(19) United States
(12) Patent Application Publication
(10) Pub. No.: US 2026/0161106 A1
(43) Pub. Date: Jun. 11, 2026

(54) ELECTROPHOTOGRAPHIC MEMBER, PROCESS CARTRIDGE AND ELECTROPHOTOGRAPHIC IMAGE FORMING APPARATUS

(71) Applicant: CANON KABUSHIKI KAISHA, Tokyo (JP)

(72) Inventors: MASAHIRO WATANABE, Shizuoka (JP); TAKAYUKI HIRATANI, Tokyo (JP); RYO OGAWA, Kanagawa (JP)

(21) Appl. No.: 19/183,346

(22) Filed: Apr. 18, 2025

Related U.S. Application Data
(63) Continuation of application No. PCT/JP2023/038247, filed on Oct. 24, 2023.

(30) Foreign Application Priority Data
Oct. 25, 2022 (JP) 2022-170647

(51) Int. Cl. G03G 5/147; C08G 64/02; G03G 15/00; G03G 21/18

(52) U.S. Cl. CPC G03G 5/14769; C08G 64/0291; G03G 5/14756; G03G 5/1476; G03G 15/751; G03G 21/1814

(57) ABSTRACT

An electrophotographic member having an elastic layer containing a urethane elastomer, wherein an outer surface of the elastic layer constitutes an outer surface of the electrophotographic member, the urethane elastomer contains a matrix and a plurality of domains dispersed in the matrix, a relationship between a parameter A indicating a viscoelasticity term of the domain and a parameter B indicating a viscoelasticity term of the matrix, which are measured in a specific viscoelasticity image of the elastic layer, satisfies A<B, a micro rubber hardness of the elastic layer at a temperature of 23° C. is 30 to 50 degrees, a proportion of the number of domains with a specific circularity based on a total number of domains observed in the specific cross section image is at least 70%, and an elastic modulus of a specific matrix at a temperature of 23° C. is 9.0 to 35.0 MPa.

### CROSS-REFERENCE TO RELATED APPLICATION

This is a continuation of International Application No. PCT/JP2023/038247, filed on Oct. 24, 2023, and designated the U.S., and claims priority from Japanese Patent Application No. 2022-170647 filed on Oct. 25, 2022, the entire contents of which are incorporated herein by reference.

### BACKGROUND OF THE INVENTION

### Field of the Invention

The present disclosure provides an electrophotographic member used in an electrophotographic image forming apparatus (hereinafter simply referred to as an “image forming apparatus”) such as an electrophotographic system copying machine and a printer. In addition, the present disclosure also provides a process cartridge and an electrophotographic image forming apparatus.

### Description of the Related Art

An image forming apparatus using an electrophotographic system (a copying machine, facsimile, or printer using an electrophotographic system) is mainly composed of an electrophotographic photosensitive member (hereinafter referred to as a “photosensitive member”), a charging apparatus, an exposure apparatus, a developing apparatus, a transfer apparatus and a fixing apparatus.

In the image forming apparatus, the photosensitive member is first charged by a charging member (hereinafter referred to as a “charging roller”) and then exposed to light and an electrostatic latent image is formed on the photosensitive member. In addition, a toner in a toner container is applied onto a toner carrying member (hereinafter referred to as a “developing roller”) by a toner control member, and transported to a developing zone by the developing roller. Thus, the toner transported to the developing zone develops the electrostatic latent image on the photosensitive member in the contact region between the photosensitive member and the developing roller. Then, the toner on the photosensitive member is transferred to recording paper by a transfer unit and fixed by heat and pressure. The toner remaining on the photosensitive member is removed by a cleaning member.

Conventionally, as materials for an elastic layer of such a charging roller or developing roller, silicone rubber, acrylonitrile butadiene rubber, epichlorohydrin rubber, and urethane elastomers have been used because of high flexibility (that is, a low hardness) thereof. Among these materials, the urethane elastomers are preferably used as materials for the elastic layer because of favorable wear resistance thereof.

However, urethane elastomers are generally prone to compression set. Therefore, in a developing roller having an elastic layer containing a urethane elastomer, if a specific segment comes into contact with a toner control member for a long time and the segment of the elastic layer that comes into contact with the toner control member is deformed, the deformation is not easily recovered. When the developing roller with a deformed specific segment is used for image formation, streaky defects may occur at positions corresponding to the deformed segment in the obtained electrophotographic image. Similarly, in the case of a charging roller having an elastic layer containing a urethane elastomer, deformation occurring at a specific segment of the charging roller may cause poor charging, and defects may occur in the electrophotographic image. When the micro rubber hardness of the urethane elastomer is lower and the temperature and the humidity are higher, the compression set tends to be larger, and the above defects are more likely to occur.

In addition, when the micro rubber hardness of the urethane elastomer is lower, the adhesiveness of the urethane elastomer tends to be stronger. When the elastic layer containing a urethane elastomer constitutes the outer surface of the developing roller or the charging roller, if the adhesiveness of the urethane elastomer is higher, the toner is fixed to the surface of the roller. As a result, poor toner regulation and poor charging may occur in the toner adhesion area, and defects may occur in the electrophotographic image. Particularly, when the temperature and the humidity are higher, the micro rubber hardness becomes lower. Therefore, even if no toner adhesion occurs at normal temperature and normal humidity, defects may occur in the electrophotographic image at high temperature and high humidity.

Japanese Patent Application Publication No. 2017-116685 discloses a conductive member having a conductive elastic layer composed of a conductive first polymer phase, a non-conductive second polymer phase, and an interfacial phase present between the first polymer phase and the second polymer phase. Japanese Patent Application Publication No. 2017-116685 discloses that the conductive elastic layer reduces sagging of the conductive member, and a conductive member having excellent restoration from deformation caused by pressure contact with another member is obtained. In addition, when a compatibilizer that causes toner adhesion is predominantly distributed in the interfacial phase, the amount of the compatibilizer that rises to the surface is reduced and toner adhesion is curbed.

### SUMMARY OF THE INVENTION

The inventors have studied the conductive roller disclosed in Japanese Patent Application Publication No. 2017-116685. As a result, the inventors have found that there is still room for improvement in the urethane elastomer disclosed in Japanese Patent Application Publication No. 2017-116685 as the material constituting the elastic layer of the developing roller or the charging roller used in a high-speed image forming apparatus.

According to studies by the inventors, the conductive elastic layer disclosed in Japanese Patent Application Publication No. 2017-116685 does not yet have a sufficient rate of recovery from deformation. Japanese Patent Application Publication No. 2017-116685 describes that the elastic recovery rate of the conductive elastic layer disclosed in Japanese Patent Application Publication No. 2017-116685 is measured using a micro hardness meter. That is, in Japanese Patent Application Publication No. 2017-116685, for the measurement of the elastic recovery rate of the conductive elastic layer disclosed in Japanese Patent Application Publication No. 2017-116685, the sample is held at a maximum pressing load of 20 mN for 5 seconds and is then released from the pressing state, and thus the elastic recovery rate is measured. However, in the results of such a test with a short maximum load retention time, even when the conductive elastic layer exhibits a fast elastic recovery rate, the rate of recovery from deformation is still slow for use as the elastic layer of the developing roller or the charging roller for a high-speed image forming apparatus under high temperature and high humidity conditions.

In addition, particularly under high temperature and high humidity conditions in which the toner becomes softer, as the printing speed is higher and the toner is fixed at a lower temperature, the toner adhered to the developing roller or the charging roller is fixed to the surface of the roller and image defects such as fogging are more likely to occur. In Japanese Patent Application Publication No. 2017-116685, when the compatibilizer that causes toner adhesion is predominantly distributed in the interfacial phase, the amount of the compatibilizer that rises to the surface is reduced and toner adhesion is curbed. However, according to studies by the inventors, since the conductive first polymer phase, the non-conductive second polymer phase, and the interfacial phase are composed of synthetic rubber which is susceptible to wear, in the high-speed image forming apparatus particularly under high temperature and high humidity conditions, the roller ends are easily scraped, the interfacial phase containing the internal compatibilizer is exposed to the surface, and the toner may be fixed thereto.

Therefore, the inventors have recognized that it is necessary to develop an elastic layer which maintains flexibility and exhibits fast recovery from deformation under high temperature and high humidity conditions, and to which no toner is fixed.

Here, generally, when the micro rubber hardness of the elastic layer is reduced, the compression set becomes larger and the rate of recovery from deformation becomes slower. On the other hand, in order to obtain an elastic layer having a low compression set and fast recovery from deformation, it is effective to increase the elastic modulus of the elastic layer. However, as the elastic modulus of the elastic layer increases, the micro rubber hardness also increases. That is, the conclusion has been come to that it is very difficult to obtain an elastic layer that has a fast rate of recovery from deformation while maintaining a low micro rubber hardness of the elastic layer.

At least one aspect of the present disclosure provides an electrophotographic member that exhibits excellent recovery from deformation under high temperature and high humidity conditions even if the member has a low hardness, and that curbs toner adhesion. In addition, at least one aspect of the present disclosure provides a process cartridge that contributes to formation of a high-quality electrophotographic image. In addition, at least one aspect of the present disclosure provides an electrophotographic image forming apparatus that can form a high-quality electrophotographic image.

According to at least one aspect of the present disclosure, there is provided an electrophotographic member comprising an elastic layer, wherein
an outer surface of the elastic layer constitutes an outer surface of the electrophotographic member,
the elastic layer comprises a urethane elastomer,
the urethane elastomer comprises a matrix and a plurality of domains dispersed in the matrix,
a relationship between a parameter A indicating a viscoelasticity term of the domain and a parameter B indicating a viscoelasticity term of the matrix, which are measured in a viscoelasticity image of a cross section of the elastic layer in which the domain and the matrix are exposed under a scanning probe microscope, satisfies A<B,
a micro rubber hardness of the elastic layer at a temperature of 23° C. is 30 to 50 degrees,
when a length of the elastic layer in a longitudinal direction is L, at a total of three locations including a center of the elastic layer in the longitudinal direction and two locations of L/4 from both ends of the elastic layer toward the center, for each cross section of the elastic layer in a thickness direction in which the domain and the matrix are exposed, in a case where a square observation region having a side of 50 m is a thickness region from the outer surface of the elastic layer to a position of a depth of 100 m, a proportion of the number of domains with a circularity of 0.60 to 0.95 based on a total number of domains observed in the obtained cross section image is at least 70%, and
an elastic modulus of the matrix present in the observation region at a temperature of 23° C. is 9.0 to 35.0 MPa.

According to at least one aspect of the present disclosure, there is provided a process cartridge configured to be detachable from a main body of an electrophotographic image forming apparatus, and comprising the electrophotographic member according to the present disclosure.

Further, according to at least one aspect of the present disclosure, there is provided an electrophotographic image forming apparatus comprising the electrophotographic member according to the present disclosure.

According to at least one aspect of the present disclosure, it is possible to obtain an electrophotographic member that exhibits excellent recovery from deformation under high temperature and high humidity conditions even if it has a low hardness and curbs toner adhesion. As a result, the electrophotographic member can be used in a high-speed image forming apparatus under high temperature and high humidity conditions. In addition, according to at least one aspect of the present disclosure, it is possible to obtain a process cartridge that contributes to formation of a high-quality electrophotographic image. In addition, according to at least one aspect of the present disclosure, it is possible to obtain an electrophotographic image forming apparatus that can form a high-quality electrophotographic image. Further features of the present invention will become apparent from the following description of exemplary embodiments with reference to the attached drawings.

### BRIEF DESCRIPTION OF THE DRAWINGS

FIG. 1 is a schematic cross-sectional view showing an example of an electrophotographic member according to one aspect of the present disclosure.

FIGS. 2A and 2B are schematic cross-sectional views showing one embodiment of an elastic layer of the electrophotographic member according to one aspect of the present disclosure.

FIGS. 3A and 3B are diagrams illustrating deformation of the elastic layer according to the present disclosure.

FIG. 4 is a diagram illustrating cutting positions and directions of a cross section.

FIG. 5 is a schematic view showing a method of producing an electrophotographic member according to one embodiment of the present disclosure.

FIG. 6 is a schematic cross-sectional view of an example of an image forming apparatus according to one embodiment of the present disclosure.

FIG. 7 is a schematic cross-sectional view of an example of a process cartridge according to one embodiment of the present disclosure.

### DESCRIPTION OF THE EMBODIMENTS

In the present disclosure the notations “from XX to YY” and “XX to YY” representing a numerical value range signify, unless otherwise specified, a numerical value range that includes the lower limit and the upper limit of the range, as endpoints. In a case where numerical value ranges are described in stages, the upper limits and the lower limits of the respective numerical value ranges can be combined arbitrarily.

The inventors speculate that the reason why deformation recovery of the conductive member for electrophotographic instruments disclosed in Japanese Patent Application Publication No. 2017-116685 is insufficient is as follows. That is, low hardness and low sagging characteristics of the conductive member for electrophotographic instruments disclosed in Japanese Patent Application Publication No. 2017-116685 are achieved by separating functions of the components of the conductive elastic layer into a conductive phase and a flexible phase (paragraph [0030] in Japanese Patent Application Publication No. 2017-116685, etc.). Here, the conductive phase and the flexible phase are formed by phase separation of two types of polymers that are incompatible with each other. Therefore, there is no chemical bond between the conductive phase and the flexible phase. Therefore, it is considered that the recovery behavior from deformation of the conductive elastic layer when a load is applied to the conductive elastic layer and the load is then removed occurs independently in the conductive phase and the flexible phase. This is speculated as one of the reasons why the recovery from deformation of the conductive elastic layer is insufficient. Based on this consideration, the inventors conducted further studies and as a result, found that a urethane elastomer having a specific structure has fast recovery from deformation under high temperature and high humidity conditions even if it has a low hardness and can curb toner adhesion. It is considered that toner adhesion can be curbed because, even if the toner penetrates into the elastic layer due to pressure contact with another member, and the contact area between the toner and the elastic layer increasing, the toner is unlikely to be detached, the elastic layer instantly recovers from the deformation and the contact area is reduced due to the deformation recovery speed increasing.

Hereinafter, an electrophotographic member according to a preferable embodiment of the present disclosure and the like will be described in detail.

### <Electrophotographic Member>

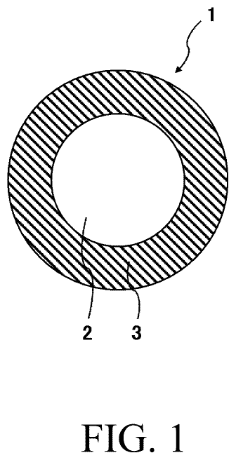

FIG. 1 is a schematic cross-sectional view of an aspect of an electrophotographic member having a roller shape (hereinafter referred to as an “electrophotographic roller”) in a circumferential direction according to the present disclosure.

An electrophotographic roller 1 shown in FIG. 1 includes a conductive shaft core 2 and an elastic layer 3 that covers the surface (outer circumferential surface) of the shaft core 2. That is, the outer surface of the elastic layer constitutes the outer surface of the electrophotographic member. Here, the electrophotographic roller according to the present disclosure is not limited to this configuration, and may have, for example, an adhesive layer (not shown) between the shaft core 2 and the elastic layer 3.

### (Shaft Core)

The shaft core 2 preferably has conductivity in order to supply power to the surface of the electrophotographic member through the shaft core. The shaft core preferably has a lower electrical resistance value than the elastic layer, and the volume resistivity of the shaft core is preferably 103 Ω·cm or less.

The conductive shaft core that is appropriately selected from among those known in the field of electrophotographic members can be used, and one made of a metal such as aluminum, aluminum alloy, stainless steel, or iron is preferable. In addition, in order to improve corrosion resistance and abrasion resistance, these metals may be plated with chromium, nickel or the like.

The shape of the shaft core may be any shape selected from among a hollow (cylindrical) shape and a solid (columnar) shape. For example, a columnar shaft core having a carbon steel alloy surface plated with nickel to a thickness of about 5 m can be used. The outer diameter of the cylindrical or columnar shaft core can be appropriately selected depending on an image forming apparatus on which it is mounted.

### (Elastic Layer)

The elastic layer 3 satisfies the following requirements (1-1) to (1-5).

Requirement (1-1): The elastic layer contains a urethane elastomer, and the urethane elastomer contains a matrix and a plurality of domains dispersed in the matrix.

Requirement (1-2): The relationship between the parameter A indicating the viscoelasticity term of the domain and the parameter B indicating the viscoelasticity term of the matrix, which are measured in a viscoelasticity image of a cross section of the elastic layer in which the domain and the matrix are exposed under a scanning probe microscope, satisfies A<B.

That is, in the cross section of the elastic layer in the thickness direction, the matrix-domain structure of the urethane elastomer is observed.

Here, the elastic modulus of the matrix of the urethane elastomer observed in the cross section of the elastic layer in the thickness direction is higher than the elastic modulus of the domain.

Requirement (1-3): The micro rubber hardness of the elastic layer at a temperature of 23° C. is 30 to 50 degrees.

Requirement (1-4): When the length of the elastic layer in a longitudinal direction is L, at a total of three locations including the center of the elastic layer in the longitudinal direction and two locations of L/4 from both ends of the elastic layer toward the center, for each cross section of the elastic layer in a thickness direction in which the domain and the matrix are exposed, if a square observation region with a side of 50 m is a thickness region from the outer surface of the elastic layer to a position of a depth of 100 m, the proportion of the number of domains with a circularity of 0.60 to 0.95 based on the total number of domains observed in the obtained cross section image is 70% or more.

Requirement (1-5): The elastic modulus of the matrix present in the observation region at a temperature of 23° C. is 9 to 35 MPa.

In the urethane elastomer, the elastic modulus of the matrix and the domain shape are responsible for a function of recovery from deformation and the elastic modulus of the matrix is responsible for a function of curbing toner adhesion. In addition, the domain is mainly responsible for a function that allows the urethane elastomer to have a low hardness. In addition, as will be described below, it is considered that, in the urethane elastomer according to the present disclosure, the domain and the matrix are chemically bonded via a urethane bond at the boundary part between the domain and the matrix. Therefore, it is considered that, when a load applied to the urethane elastomer is removed, the recovery of the domain from deformation proceeds in linkage with the recovery of the matrix from deformation. Therefore, the elastic layer according to the present disclosure is thought to have very fast recovery from deformation. When such a urethane elastomer is used, the elastic layer exhibits softness, fast recovery from deformation, and curbs toner adhesion.

Here, in general urethane elastomers, there is a difference in elastic modulus between a so-called hard segment and soft segment. However, in general urethane elastomers, the soft segment constitutes the matrix, and the hard segment constitutes the domain, and the elastomers are not thought to exhibit a fast recovery rate from deformation required by the requirements (1-4) and (1-5) while having flexibility required by the requirement (1-3).

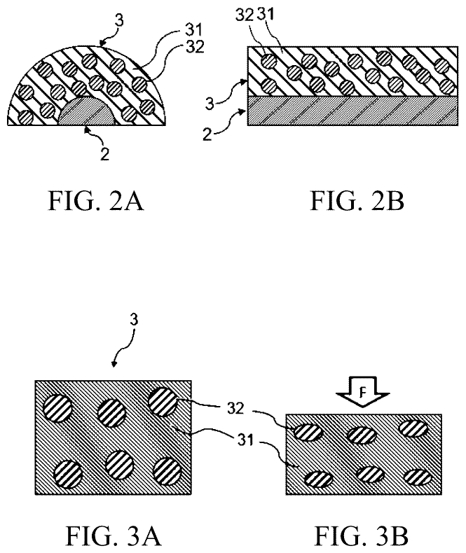

FIG. 2A is a partial cross-sectional view of an electrophotographic roller 1A in the circumferential direction according to one aspect of the present disclosure. In addition, FIG. 2B is a partial cross-sectional view along the longitudinal direction of the shaft core 2 of the electrophotographic roller 1A.

FIG. 2A and FIG. 2B schematically show a matrix 31 and a plurality of domains 32 dispersed in the matrix 31 that the urethane elastomer contains, which are observed in a cross section of the elastic layer 3 in the thickness direction.

As described above, the urethane elastomer contains the matrix 31 and the plurality of domains 32 dispersed in the matrix. Thus, the matrix exhibits higher elasticity than the domain.

In addition, it is preferable that at least a part of the outer surface of the elastic layer be formed of a matrix. In the electrophotographic roller shown in FIG. 2A and FIG. 2B, an example in which the entire outer surface of the elastic layer 3 is formed of a matrix is shown.

Here, FIG. 3A and FIG. 3B are diagrams illustrating recovery of the elastic layer 3 from deformation according to the present disclosure. As shown in FIG. 3A, the plurality of domains 32 are dispersed in the matrix 31. Thus, since the domain 32 has lower elasticity than the matrix 31, as shown in FIG. 3B, when the elastic layer 3 is compressed in the direction of the arrow F, the domain 32 deforms preferentially. Therefore, even if the matrix 31 has high elasticity, the micro rubber hardness of the elastic layer can be reduced. In addition, when the compressed elastic layer is released, the thickness of the elastic layer can be quickly returned to the thickness before compression due to the elasticity of the matrix 31 in a continuous phase. That is, the matrix 31 exhibits fast recovery from deformation.

### (Micro Rubber Hardness of Elastic Layer)

The micro rubber hardness of the elastic layer at a temperature of 23° C. is 30 to 50 degrees. When the micro rubber hardness is 50 degrees or less, the nip width between the developing roller and the toner control member and the nip width between the charging roller and the photosensitive member increase, and the contact pressure does not become excessively large. This makes it unlikely for the toner on the developing roller to melt adhesion on the developing roller and for the toner that has slipped through the cleaning member and adhered to the charging roller to melt adhesion on the charging roller. In addition, when the micro rubber hardness is 30 degrees or more, the mechanical strength increases, and the ends of the elastic layer are less likely to be scraped off even when used in a high-speed image forming apparatus under high temperature and high humidity conditions. The micro rubber hardness is preferably 32 to 45 degrees and more preferably 33 to 40 degrees.

The micro rubber hardness can be adjusted by the elastic modulus of the matrix, the ratio of the matrix to the domain, or the like. Specifically, for example, increasing the elastic modulus of the matrix and decreasing the ratio (volume) of the domain to the matrix act in the direction in which the micro rubber hardness increases.

The micro rubber hardness can be determined, for example, as follows. Regarding the location for measuring the micro rubber hardness, when the length of the elastic layer in a longitudinal direction is L, a total of three locations including the center of the elastic layer in the longitudinal direction and two locations of L/4 from both ends of the elastic layer toward the center are used. At each measurement location, the micro rubber hardness of the surface is measured using a micro rubber hardness meter (product name: MD-1capa; commercially available from Kobunshi Keiki Co., Ltd., push needle: type A (push pin shape: cylindrical, a diameter of 0.16 mm, a height of 0.5 mm, a pressure leg size: an outer diameter of 4 mm, an inner diameter of 1.5 mm), measurement mode: a peak hold mode) at a temperature of 23° C.

### (Parameter Indicating Viscoelasticity Term)

The matrix 31 and the domain 32 have a relationship between the parameter A indicating the viscoelasticity term of the domain and the parameter B indicating the viscoelasticity term of the matrix, which is measured in a viscoelasticity image under a scanning probe microscope, satisfies A<B.

The parameters A and B can be determined by preparing a section from the elastic layer and measuring the section under a scanning probe microscope (SPM/AFM). As the scanning probe microscope, for example, “S-Image” (product name, commercially available from Hitachi High-Tech Science Corporation) can be used.

In addition, examples of sectioning units include a sharp razor, a microtome, and a focused ion beam (FIB), and a microtome is used in the present disclosure.

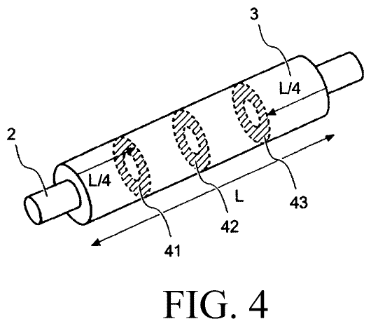

The locations for preparing sections are a total of three locations including the center of the elastic layer in the longitudinal direction and two locations of L/4 from both ends of the elastic layer toward the center when the length of the elastic layer in a longitudinal direction is L. Thus, as shown in FIG. 4, a total of three sections are prepared from cross sections 41 to 43 of the elastic layer in the thickness direction. As a result, the obtained section has a cross section in which the domain and the matrix are exposed.

In addition, the region of the electrophotographic member that deforms when it comes into contact with another member is mainly a thickness region from the outer surface of the elastic layer to a position of a depth of 100 m. Therefore, the observation region is a thickness region from the surface of the elastic layer to a position of a depth of 100 m. Specifically, regarding the observation regions of the cross sections 41 to 43, square observation regions with a side of 50 m in the thickness region from the outer surface of each section to a position of a depth of 100 m are selected, and viscoelasticity images are observed in a total of three observation regions.

The measurement mode for the viscoelasticity image taken by SPM is a micro viscoelastic dynamic force mode (VE-DFM). In addition, as the cantilever, a silicon microcantilever for DFM (“SI-DF3” (product name), commercially available from Hitachi High-Tech Science Corporation, spring constant=1.9 N/m) is used. In addition, the scanning frequency is 0.5 Hz.

Here, VE-DFM is one of the measurement modes of the scanning probe microscope (SPM). In VE-DFM, an image of the surface shape can be obtained which controlling the distance between the probe and the measurement sample so that the vibration and amplitude of the cantilever are constant while the cantilever is resonating. In addition, in VE-DFM, the viscoelasticity distribution can be imaged from the deflection amplitude of the cantilever when a periodic force is applied by micro-vibrating the sample in the Z direction. When the sample is hard, the sample deformation is small, and the cantilever amplitude is large, and when the sample is soft, the sample deformation vibration is induced, and the cantilever amplitude is small.

The obtained amplitude is converted into displacement in mV, which becomes the parameter indicating the viscoelasticity term. Therefore, the parameter A and the parameter B are indexes indicating the relationship between the hardness of the domain and the hardness of the matrix present in one observation sample. Here, in VE-DFM, the magnitude of the amplitude of the cantilever is output as a voltage, and thus the units of the parameter A and the parameter B are mV. In addition, a larger value indicates higher elasticity.

After the viscoelasticity image is obtained, in each observation region, the parameters indicating the viscoelasticity term are obtained for 10 points each for the matrix and the domain, and their arithmetic average values are taken as the parameter A indicating the viscoelasticity term of the domain and the parameter B indicating the viscoelasticity term of the matrix. The measurement procedure will be described below.

The ratio (A/B) of the parameter A (mV) to the parameter B (mV) is preferably 0.65 or less, more preferably 0.60 or less, still more preferably 0.50 or less, yet more preferably 0.40 or less, and particularly preferably 0.32 or less. When the A/B is smaller, since the difference in viscoelasticity between the matrix and the domain is larger, it becomes easier to achieve both hardness and recovery from deformation. The lower limit of A/B is not particularly limited, and a smaller value is more preferable. Specifically, for example, it is 0.10. The preferable range of A/B is, for example, from 0.10 to 0.65, from 0.10 to 0.60, from 0.10 to 0.50 or less, particularly from 0.10 to 0.40, and further, from 0.10 to 0.30.

The parameters A and B can be adjusted, for example, by the elastic modulus of the domain and the matrix. The elastic modulus of the matrix can be increased by, for example, increasing the crosslink density of the matrix using a polyisocyanate trimeric compound or polymeric compound as a matrix-forming raw material. Regarding the elastic modulus of the domain, for example, by increasing the molecular weight of the polyether polyol as a domain-forming raw material, the crosslink density of the domain decreases, and the elastic modulus decreases.

### (Elastic Modulus of Matrix)

The elastic modulus of the matrix 31 present in the observation region at a temperature of 23° C. is 9.0 to 35.0 MPa. When the elastic modulus of the matrix is 9.0 MPa or more, the spring effect of the matrix becomes large, and the recovery from deformation can be made fast. In addition, the adhesiveness of the matrix decreases, and toner adhesion can be curbed even under high temperature and high humidity conditions. On the other hand, when the elastic modulus of the matrix is 35.0 MPa or less, the micro rubber hardness of the elastic layer can be kept low. The elastic modulus of the matrix is more preferably 11.0 to 30.0 MPa and still more preferably 16.0 to 23.0 MPa.

The elastic modulus of the matrix can be adjusted, for example, by adjusting the crosslink density of the matrix using a polyisocyanate trimeric compound or polymeric compound. However, generally, as the elastic modulus of the matrix increases, the micro rubber hardness of the elastic layer also increases at the same time. Particularly, when the crosslink density of the matrix is increased with isocyanate, the number of urethane bonds in the hard segments also increases, and thus the micro rubber hardness may become excessively high beyond the increase in the elastic modulus of the matrix.

As a method for increasing the elastic modulus of the matrix without excessively increasing the micro rubber hardness, there is a method for reducing the amount of domain components present in the matrix. Matrix components and domain components may not be completely phase-separated into a matrix and a domain, and some domain components may be mixed into the matrix. In the urethane elastomer contained in the elastic layer, since the elastic modulus of the domain is smaller than the elastic modulus of the matrix, the elastic modulus of the matrix decreases in this case. As a result, the adhesiveness of the matrix increases and toner adhesion is likely to occur.

In addition, when a urethane elastomer is produced by a production method that uses a urethane reactive emulsifier to be described below, since the urethane reactive emulsifier has a structure in which a matrix structure and a domain structure are bonded, the urethane reactive emulsifier having a domain structure may be mixed into the matrix in the step (ii) to be described below. Particularly, since a urethane reactive emulsifier in which a matrix structure is bonded to both ends of a domain structure has a high matrix structure proportion, it is easily mixed into the matrix.

Therefore, when the urethane elastomer is produced by the production method that uses a urethane reactive emulsifier, a urethane reactive emulsifier in which a matrix structure and a domain structure are bonded at a ratio of 1:1 is preferable. Compared to a urethane reactive emulsifier in which a matrix structure is bonded to both ends of a domain, and a matrix structure and a domain structure are bonded at a ratio of 1:2, since the matrix structure proportion is reduced, the amount of the urethane reactive emulsifier mixed into the matrix is also reduced, and an excessive decrease in the elastic modulus of the matrix can be reduced.

The elastic modulus of the matrix can be calculated by preparing a section of the elastic layer and measuring the section under a scanning probe microscope (SPM/AFM). As the scanning probe microscope, for example, “MFP-3D-Origin” (product name, commercially available from Oxford Instruments) can be used.

In addition, examples of sectioning units include a sharp razor, a microtome, and a focused ion beam (FIB).

The locations for preparing sections are a total of three locations including the center of the elastic layer in the longitudinal direction and two locations of L/4 from both ends of the elastic layer toward the center when the length of the elastic layer in a longitudinal direction is L. Thus, as shown in FIG. 4, a total of three sections are prepared from cross sections 41 to 43 of the elastic layer in the thickness direction. As a result, the obtained section has a cross section in which the domain and the matrix are exposed.

In addition, for the same reason as in the measurement of the parameter indicating the viscoelasticity term, regarding the observation regions of the cross sections 41 to 43, square observation regions with a side of 50 m in the thickness region from the outer surface of each section to a position of a depth of 100 m are selected, and phase images are observed in a total of three observation regions.

The measurement mode for the phase image taken by SPM is AM-AFM. In addition, as the cantilever, a silicon cantilever for dynamic mode, for example, “OMCL-AC-160TS” (product name, commercially available from Olympus Corporation, spring constant=47.08 N/m) is used. In addition, the scanning frequency is 0.5 Hz.

After a phase image is obtained, a force curve is measured using an SPM in order to measure the elastic modulus of the matrix. The force curve measurement mode is a contact mode, Force Distance is 500 nm, and Trigger Point is 0.01 V. In addition, as the cantilever, similarly to the above, a silicon cantilever for dynamic mode, for example, “OMCL-AC-160TS” (product name, commercially available from Olympus Corporation, spring constant=47.08 N/m) is used. The scanning frequency is 1 Hz.

The elastic modulus of the matrix is calculated at 10 points in each of three observation regions, for a total of 30 points, and the arithmetic average value thereof is taken as the elastic modulus of the matrix.

### (Circularity of Domain)

When the length of the elastic layer in a longitudinal direction is L, at a total of three locations including the center of the elastic layer in the longitudinal direction and two locations of L/4 from both ends of the elastic layer toward the center, for each cross section of the elastic layer in the thickness direction in which the domain and the matrix are exposed, if a square observation region with a side of 50 m is a thickness region from the outer surface of the elastic layer to a position of a depth of 100 m, the proportion of the number of domains with a circularity of 0.60 to 0.95 based on the total number of domains observed in the obtained cross section image is 70% or more. The proportion of the number of domains is more preferably 80% or more and still more preferably 90% or more. In addition, the upper limit may be 100% or less or 98% or less. For example, it is preferably 70 to 100%, 80 to 100%, or 90 to 98%.

In the case of domains having a circularity within the above range, when the domains recover from deformation, anisotropy is unlikely to occur in a direction in which the domain shape recovers. Thus, when the number (proportion) of domains having a circularity within the above range increases, the recovery of the elastic layer from deformation is less likely to be anisotropic. In other words, an elastic layer can be made to recover from deformation more isotropically. As a result, wrinkles and the like due to anisotropy in the recovery from deformation are unlikely to occur in the elastic layer after recovery from deformation, and the elastic layer uniformly recovers from the deformation.

Here, simultaneously with the above measurement of the cross-sectional area and number of domains, the circularity and number of domains can be obtained using a count function of image processing software. Details will be described below.

The proportion of the number of domains with a circularity of 0.60 to 0.95 can be adjusted, for example, by the speed at which the material is injected into the mold. When the injection speed is low, the shear force applied to the material is also reduced, and thermal curing can be performed while maintaining a high circularity.

When the length of the elastic layer in a longitudinal direction is L, at a total of three locations including the center of the elastic layer in the longitudinal direction and two locations of L/4 from both ends of the elastic layer toward the center, for each cross section of the elastic layer in the thickness direction in which the domain and the matrix are exposed, if a square observation region with a side of 50 m is a thickness region from the outer surface of the elastic layer to a position of a depth of 100 m, the average circularity of the domains observed in the obtained cross section image is preferably 0.55 to 1.00. In addition, it is more preferably 0.60 to 1.00 and still more preferably 0.80 to 1.00.

Within the above range, it becomes easy to adjust the proportion of the number of domains with a circularity of 0.60 to 0.95 to be within the above range.

The average circularity of the domains can be adjusted, for example, by the speed at which the material is injected into the mold. When the injection speed is low, the shear force applied to the material is also reduced, and thermal curing can be performed while maintaining a high circularity.

(Recovery from Deformation)

For the elastic layer 3, when a Vickers indenter is brought into contact with the matrix at the outer surface of the elastic layer at a temperature of 23° C., the Vickers indenter is pressed into the elastic layer at a load rate of 10 mN/30 seconds, a load of 10 mN is maintained for 60 seconds, and the load is then removed, the strain 5 seconds after unloading is preferably 0.55 μm or less. The strain 5 seconds after unloading is more preferably 0.50 μm or less and still more preferably 0.40 μm or less. In addition, the lower limit of the strain 5 seconds after unloading is not particularly limited, and is generally 0.00 μm, and may be 0.05 μm, or 0.10 μm. For example, it is preferably 0.00 to 0.55 μm, 0.00 to 0.50 μm, or 0.00 to 0.40 μm.

When the strain 5 seconds after unloading measured under the above conditions is within the above range, it is possible to curb streaky image defects when applied as a developing roller in a high-speed printer. This is because the deformation of the developing roller can be recovered to a size equal to or smaller than that of a single normal toner in a short time from when the high-speed printer operates until an electrostatic latent image develops. In addition, even when applied to a charging roller, since the recovery from deformation is fast, uneven discharging to the photosensitive member is unlikely to occur, and it is possible to prevent the occurrence of streaky image defects due to uneven charging of the photosensitive member.

As described above, in the elastic layer according to the present disclosure, it is considered that the domain and the matrix are chemically bonded via a urethane bond at the boundary part between the domain and the matrix. Therefore, it is considered that the recovery of the domain from deformation when the load applied to the urethane elastomer is removed is linked to the recovery of the matrix from deformation. Therefore, it is considered that the recovery from deformation is very fast, and the strain 5 seconds after unloading can be kept within the above range.

The strain 5 seconds after unloading can be adjusted, for example, by the elastic modulus of the matrix, assuming that the matrix and the domain are chemically bonded. Specifically, for example, by increasing the crosslink density of the matrix of the urethane elastomer using a polyisocyanate trimeric compound or polymeric compound as at least one of raw materials of the urethane elastomer, the elastic modulus of the matrix can be increased.

Here, the value of the strain 5 seconds after unloading is a value obtained by an indentation test using a micro hardness tester (nanoindenter). The measurement temperature is a temperature of 23° C. In addition, the indenter used for measurement is a Vickers indenter with a square pyramid shape and a facing angle of 136°. In the measurement method, a Vickers indenter is brought into contact with a matrix part at the surface of the elastic layer, the Vickers indenter is pressed into the elastic layer at a load rate of 10 mN/30 seconds, and a load of 10 mN is maintained for 60 seconds. Next, the load is removed (unloading) at an unload rate of 10 mN/l sec, and the strain of the elastic layer 5 seconds after unloading is measured. In addition, when the length of the elastic layer in a longitudinal direction is L, the measurement positions are a total of three locations including the center of the elastic layer in the longitudinal direction and two locations of L/4 from both ends of the elastic layer toward the center.

### (Cross-Sectional Area and Number of Domains)

The cross-sectional area and number of domains 32 of the urethane elastomer observed in a cross section of the elastic layer in the thickness direction will be described.

When the length of the elastic layer in a longitudinal direction is L, at a total of three locations including the center of the elastic layer in the longitudinal direction and two locations of L/4 from both ends of the elastic layer toward the center, for each cross section of the elastic layer in the thickness direction in which the domain and the matrix are exposed, if a square observation region with a side of 50 m is a thickness region from the outer surface of the elastic layer to a position of a depth of 100 m, it is preferable that each observation region satisfy the following requirement (2-1) and requirement (2-2).

Requirement (2-1): The proportion of the total cross-sectional area of the domains present in the observation region is 25 to 45 area % of the area of the observation region.

Requirement (2-2): Among the domains present in the observation region, the proportion of the number of domains having a cross-sectional area of 0.10 to 13.00 area % relative to the area of the observation region is 70% or more.

Regarding the requirement (2-1), when the proportion of the total cross-sectional area of the domains present in the observation region is 25 area % or more, the micro rubber hardness of the elastic layer can be kept lower. In addition, when the proportion of the total cross-sectional area of the domains is 45 area % or less, the recovery of the elastic layer from deformation can be made fast.

In addition, the proportion of the total cross-sectional area of the domains present in the observation region is more preferably 25 to 35 area %.

For example, when the matrix has a polycarbonate structure represented by Formula (1), and the domain has a polyether structure represented by Formula (2), the proportion of the total cross-sectional area of the domains can be adjusted by changing the content proportions of the polycarbonate structure (represented by Formula (1)) contained in the matrix and the polyether structure (represented by Formula (2)) contained in domain. For example, when the content proportion of the polyether structure represented by Formula (2) increases, the proportion of the total cross-sectional area of the domains increases. In addition, when the content proportion of the polyether structure represented by Formula (2) is within the above range, the matrix and the domain are less likely to be reversed, and the polyether structure represented by Formula (2) is less likely to become the main component of the matrix.

In addition, the cross-sectional area of the domain can be increased, for example, by increasing the number average molecular weight of the polyether polyol that forms the polyether structure represented by Formula (2).

Regarding the requirement (2-2), when the proportion of the number of domains having a cross-sectional area of 0.10 to 13.00 area % relative to the area of the observation region is 70% or more of the total number of domains in the observation region, a number of domains large enough to be deformed sufficiently when the elastic layer is pressed against is secured. Therefore, the micro rubber hardness of the elastic layer can be made lower. In addition, since the number of large domains that deform excessively when a load is applied to the elastic layer is small, it is possible to curb the micro rubber hardness of the elastic layer becoming too low.

In addition, the proportion of the number of domains having a cross-sectional area of 0.10 to 13.00 area % relative to the area of the observation region is preferably 70 to 100%, more preferably 80 to 100%, and still more preferably 90 to 100%.

The proportion of the number of domains having a cross-sectional area of 0.10 to 13.00 area % relative to the area of the observation region can be adjusted by the size of the cross-sectional area of the domain. The proportion of the number of domains satisfying the above requirement is higher as the size of the cross-sectional area of the domain is closer to the center of the range of the above requirement. As described above, the size of the cross-sectional area of the domain can be adjusted by the number average molecular weight of the polyether polyol that forms the polyether structure represented by Formula (2), and increases when the number average molecular weight of the polyether polyol increases. In addition, the cross-sectional area of the domain is reduced by increasing the isocyanate index in the step of obtaining a first polyether to be described below and increasing the shear force when materials are mixed.

The measurement of the proportion of the total cross-sectional area of the domains present in the observation region and the proportion of the number of domains having a cross-sectional area of 0.10 to 13.00 area % relative to the area of the observation region will be described below.

In addition, the average cross-sectional area of the domains present in the observation region relative to the area of the observation region is preferably 0.08 to 16.00 area %, more preferably 0.10 to 15.00 area %, and still more preferably 0.10 to 13.00 area %.

Within the above range, it becomes easily to adjust the proportion of the number of domains having a cross-sectional area of 0.10 to 13.00 area % relative to the area of the observation region.

As described above, the average cross-sectional area of the domains can be adjusted by the number average molecular weight of the polyether polyol that forms the polyether structure represented by Formula (2), and increases when the number average molecular weight of the polyether polyol increases. In addition, the average cross-sectional area of the domains is reduced by increasing the isocyanate index in the step of obtaining a first polyether to be described below and increasing the shear force when materials are mixed.

### (Material for Elastic Layer)

The urethane elastomer will be described. As described above, the elastic layer contains a urethane elastomer, and the urethane elastomer contains the matrix 31 and the plurality of domains 32 dispersed in the matrix. That is, the urethane elastomer has a matrix-domain structure.

In this case, it is preferable that the matrix 31 have a structure that can increase a deformation recovery speed and the domain 32 have a structure that contributes to curbing an increase in micro rubber hardness.

The fact that the elastic layer contains a urethane elastomer can be determined by analysis using, for example, a spectroscopic analyzer such as a microscopic infrared spectroscopic analyzer or a mass spectrometer.

The matrix 31 preferably has a polycarbonate structure represented by the following Formula (1).

A polyurethane obtained by reacting a polyol having a polycarbonate structure (polycarbonate polyol) with a polyisocyanate exhibits high elasticity due to the strong intermolecular force between carbonate groups. Therefore, it is preferable as a structure to be contained in the matrix. The matrix has at least one polycarbonate structure represented by Formula (1) and preferably has a plurality of polycarbonate structures. When the matrix has a plurality of polycarbonate structures represented by Formula (1), the polycarbonate structures can be repeating structure units.

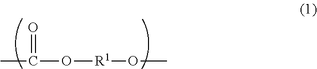

(in Formula (1), R¹ is an alkylene group having 3 to 9 (preferably 3 to 6) carbon atoms).

An alkylene group having 3 to 9 carbon atoms represented by R¹ in Formula (1) may have a linear structure or a branched structure, and more preferably has a branched structure.

When R¹ is an alkylene group having 3 to 9 carbon atoms, the incompatibility with the domain having a polyether structure represented by the following Formula (2) to be described below is secured, and the matrix and the domain can be clearly phase-separated. Therefore, the urethane elastomer can more reliably exhibit two functions of softness and fast recovery from deformation.

In addition, when R¹ is an alkylene group having a branched structure and having 3 to 9 (preferably 4 to 9) carbon atoms, it is possible to appropriately reduce the intermolecular force between carbonate groups and it is possible to curb the elasticity of the matrix becoming excessively high.

Examples of R¹'s include —(CH₂)ₘ— (m=3 to 9, preferably 3 to 6), —CH₂C(CH₃)₂CH₂—, —CH₂CH(CH₃)CH₂—, and —(CH₂)₂CH(CH₃)(CH₂)₂—. These may be used alone or two or more thereof may be used in combination.

The fact that the matrix has a polycarbonate structure represented by Formula (1) and R¹ is an alkylene group having 3 to 9 carbon atoms can be determined by analysis using, for example, a spectroscopic analyzer such as a microscopic infrared spectroscopic analyzer or a mass spectrometer.

The domain 32 preferably has a polyether structure represented by the following Formula (2). Polyether exhibits a low elastic modulus due to the weak intermolecular force between ether groups. Therefore, it is preferable as a structure to be contained in the domain. The domain has at least one polyether structure represented by Formula (2) and preferably has a plurality of polyether structures. When the domain has a plurality of polyether structures represented by Formula (2), the polyether structures can be repeating structure units.

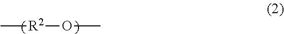

(in Formula (2), R² is an alkylene group having 3 to 5 (preferably 4 to 5) carbon atoms).

An alkylene group having 3 to 5 carbon atoms represented by R² in Formula (2) may have a linear structure or a branched structure, and preferably has a branched structure.

When R² is an alkylene group having 3 to 5 carbon atoms, the incompatibility with the matrix having a polycarbonate structure represented by Formula (1) is secured, and the matrix and the domain can be clearly phase-separated. Therefore, the urethane elastomer can more reliably exhibit two functions of softness and fast recovery from deformation.

In addition, when R² is an alkylene group having a branched structure and having 3 to 5 (preferably 4 to 5) carbon atoms, it is possible to curb crystallization of the domain and it is possible to more easily reduce the hardness of the domain. As a result, the domain tends to have a low elastic modulus.

Examples of R²'s include —(CH₂)ₘ— (m=3 to 5, preferably 4 to 5), —CH₂CH(CH₃)—, —CH₂C(CH₃)₂CH₂—, —CH₂CH(CH₃)CH₂—, and —(CH₂)₂CH(CH₃)CH₂—. These may be used alone or two or more thereof may be used in combination.

The fact that the domain has a polyether structure represented by Formula (2) and R² is an alkylene group having 3 to 5 carbon atoms can be determined by analysis using, for example, a spectroscopic analyzer such as a microscopic infrared spectroscopic analyzer or a mass spectrometer.

A conducting agent can be added to the elastic layer in order to adjust the electrical resistance of the electrophotographic roller. The volume resistivity of the elastic layer can be adjusted using an ion conducting agent or an electron conducting agent.

Examples of ion conducting agents include the following: cations such as quaternary ammonium salts, imidazolium salts, and pyridinium salts, and anions such as perchlorate anions, fluoroalkylsulfonylimide anions, fluorosulfonylimide anions, trifluoromethanesulfonate anions, and tetrafluoroborate anions. These may be used alone or two or more thereof may be used in combination.

Examples of electron conducting agents include the following: metal-based fine particles and fibers such as aluminum, palladium, iron, copper, and silver, conductive metal oxides such as titanium oxide, tin oxide, and zinc oxide, composite particles in which the surfaces of the metal-based fine particles, fibers or metal oxides are subjected to a surface treatment by an electrolysis treatment, spray coating, or mixing and shaking, and carbon powders such as furnace black, thermal black, acetylene black, ketjen black, polyacrylonitrile (PAN)-based carbon, and pitch-based carbon. These may be used alone or two or more thereof may be used in combination.

In addition, as necessary, additives such as a pigment, a plasticizer, a water-proofing agent, an antioxidant, a UV absorbing agent, and a light stabilizer may be used in combination.

### (Method for Producing Urethane Elastomer)

As an example of a method for producing the urethane elastomer, a method including the following steps (i) to (iii) may be exemplified.

Step (i): a step of obtaining a urethane reactive emulsifier having at least two hydroxyl groups by reacting a first polyether having at least one isocyanate group with a first polycarbonate polyol having at least two hydroxyl groups.

Step (ii): a step of mixing the urethane reactive emulsifier and a second polycarbonate polyol to obtain a dispersion in which droplets containing at least a part of the urethane reactive emulsifier are dispersed in the second polycarbonate polyol.

Step (iii): a step of preparing an elastic layer-forming mixture containing the dispersion obtained in the step (ii) and a polyisocyanate having at least two isocyanate groups, and then reacting the urethane reactive emulsifier, the second polycarbonate polyol, and the polyisocyanate having at least two isocyanate groups in the elastic layer-forming mixture.

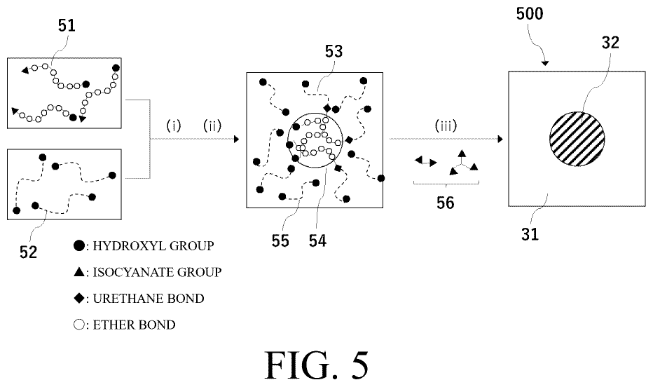

The steps of the production method will be described with reference to FIG. 5.

In the step (i), a first polyether 51 having at least one isocyanate group and a first polycarbonate polyol 52 having at least two hydroxyl groups are mixed. In the presence of a catalyst, isocyanate groups and hydroxyl groups in the mixture are reacted with each other to link them via urethane bonds, and thus a urethane reactive emulsifier 53 having at least two hydroxyl groups is obtained. The urethane reactive emulsifier is a reactive emulsifier having a urethane bond.

In the step (ii), in a second polycarbonate polyol 55, the urethane reactive emulsifier 53 obtained in the step (i) is dispersed. Here, the urethane reactive emulsifier can be mixed with the second polycarbonate polyol newly added in this step. In addition, an excess unreacted material of the first polycarbonate polyol in the step (i) can also be used as a second polycarbonate polyol.

The first polyether 51 contained in the urethane reactive emulsifier 53 is incompatible with the second polycarbonate polyol 55 and forms droplets 54.

On the other hand, the first polycarbonate polyol 52 contained in the urethane reactive emulsifier 53 is compatible with the second polycarbonate polyol 55. Therefore, droplets 54 containing the first polyether constituting a part of the urethane reactive emulsifier are uniformly and stably dispersed in the second polycarbonate polyol 55 via the first polycarbonate polyol 52. As a result, a dispersion in which the droplets 54 containing the first polyether 51 of the urethane reactive emulsifier 53 are dispersed in the second polycarbonate polyol 55 is obtained. Here, the step (i) and the step (ii) are described separately for the sake of explanation, but these steps may be a series of continuous steps.

In the step (ii), the second polycarbonate polyol 55 in which the droplets 54 are dispersed may be the unreacted material with the first polyether in the first polycarbonate polyol used in the step (i). That is, in the step (i), when an excess amount of the first polycarbonate polyol relative to the first polyether is used, it is possible to obtain a dispersion in which the urethane reactive emulsifier 53 described in the step (ii) is dispersed in an excess amount of the first polycarbonate polyol (that is, the second polycarbonate polyol 55). Here, even when an excess amount of the first polycarbonate polyol is used, it is possible to add a polycarbonate polyol (second polycarbonate polyol) as a dispersion medium for the urethane reactive emulsifier. In this case, the polycarbonate polyol to be added may have the same chemical composition as the first polycarbonate polyol used in the step (i) or may have a different chemical composition.

On the other hand, in the step (i), when the first polycarbonate polyol and the first polyether are reacted in equivalent amounts, and the first polycarbonate polyol is completely consumed, in the step (ii), a new polycarbonate polyol is used as the second polycarbonate polyol to prepare a dispersion. In this case, the polycarbonate polyol used as the second polycarbonate polyol may have the same chemical composition as the first polycarbonate polyol or may have a different chemical composition.

Finally, in the step (iii), an elastic layer-forming mixture containing the dispersion prepared in the step (ii) and a polyisocyanate 56 having at least two isocyanate groups is prepared. Next, hydroxyl groups of the urethane reactive emulsifier 53, or hydroxyl groups of the second polycarbonate polyol 55, and isocyanate groups of the polyisocyanate 56 in the elastic layer-forming mixture are reacted with each other. In this manner, a network structure is formed via a urethane bond, and the elastic layer-forming mixture is cured to obtain a urethane elastomer. A urethane elastomer 500 obtained in this manner has a matrix-domain structure in which the domain 32 having a polyether structure of the first polyether 51 is dispersed in the matrix 31 having a polycarbonate structure of the first polycarbonate polyol 52 and the second polycarbonate polyol 55 which are unreacted materials. In addition, the domain 32 can be mainly composed of a polyether structure, and the inside of the domain can be substantially free of a cross-linked structure. In other words, the domain 32 can be present in a substantially liquid state in the matrix. Therefore, in the urethane elastomer, the domain can have a low elastic modulus.

In addition, it is considered that the domain is not simply trapped in the matrix, the domain and the matrix are chemically bonded via a urethane bond at the boundary part between the domain and the matrix. Therefore, when the load applied to the urethane elastomer is removed, the recovery of the domain from deformation can be linked to the recovery of the matrix from deformation. Therefore, the elastic layer according to the present disclosure is thought to have very fast recovery from deformation. In addition, when the recovery of the domain from deformation is linked to the recovery of the matrix from deformation, the elastic layer is able to recover better and more stably from deformation even when it is repeatedly subjected to loading and unloading.

Here, as described above, the domain can be in a substantially liquid state with substantially no internal cross-linked structure. This makes it possible to further increase the flexibility of the urethane elastomer. In this case, since the substantially liquid domain that has been deformed by application of a load to the urethane elastomer has a low elastic modulus, it is considered difficult for the domain to spontaneously recover from deformation. However, it is considered that, in the urethane elastomer according to the present disclosure, as described above, the domain and the matrix are chemically bonded at the boundary part with the matrix. Due to the presence of the chemical bond, the substantially liquid domain can also recover well from deformation together with the deformation recovery of the matrix. Therefore, the urethane elastomer having substantially liquid domains according to the present disclosure can achieve higher levels of flexibility and the recovery from deformation.

Here, the steps (i) to (ii) are steps of stably dispersing a polyether, which is inherently poorly compatible and difficult to disperse stably and uniformly, in a polycarbonate polyol. That is, the first polyether 51 is reacted with the first polycarbonate polyol 52 to form the urethane reactive emulsifier 53. This is a step of obtaining a dispersion in which a polyether segment corresponding to the first polyether 51 is stably and uniformly dispersed in a second polycarbonate polyol. Therefore, it is easy to prepare the urethane elastomer in which the domains 32 having a high circularity, small sizes on the micrometer order, and a relatively uniform size distribution are dispersed in the matrix 31.

Here, another method for mixing materials with low compatibility is, for example, a mixing and dispersing method using a high shear force. However, in this method, a high shear force is applied to the polyether, and as a result, the shapes of the domains are distorted, the circularity decreases, and the sizes of the domains also become non-uniform. In addition, the dispersion state is also unstable, and the domains aggregate in a relatively short time. In addition, the incompatibility between the polyether and the polycarbonate polyol is not secured, and the phase separation between the matrix and the domain of the obtained urethane elastomer becomes unclear. Therefore, it is difficult to obtain a urethane elastomer according to the present disclosure that provides an elastic component that is flexible and has excellent deformation recovery.

The first polyether has at least one isocyanate group. In addition, the first polyether is preferably a polyether having a polyether structure represented by Formula (2). The first polyether can be obtained, for example, through a step of reacting a polyether polyol having at least two hydroxyl groups and having a polyether structure represented by Formula (2) with a polyisocyanate having at least two isocyanate groups.

Examples of polyether polyols include alkylene structure-containing polyether-based polyols such as polypropylene glycol, polytetramethylene glycol, copolymers of tetrahydrofuran and neopentyl glycol, copolymers of tetrahydrofuran and 3-methyltetrahydrofuran, and random or block copolymers of these polyalkylene glycols. These may be used alone or two or more thereof may be used in combination.

Among polyether polyols, an amorphous polyether polyol is preferable because the incompatibility with the second polycarbonate polyol and a low hardness can be achieved.

It is more preferable to contain at least one selected from the group consisting of polypropylene glycol, copolymers of tetrahydrofuran and neopentyl glycol, and copolymers of tetrahydrofuran and 3-methyltetrahydrofuran.

The number average molecular weight of the polyether polyol is preferably 1,000 to 50,000 and more preferably 1,200 to 30,000. When the number average molecular weight is 1,000 or more, this is preferable because the incompatibility with the polycarbonate polyol is secured and the phase separation between the matrix and the domain of the obtained urethane elastomer becomes clear. In addition, when the number average molecular weight is 50,000 or less, this is preferable because domains are easily formed and the phase separation form becomes stable.

The number average molecular weight of the polyether polyol can be calculated by the following Formula (3) using the hydroxy value (mg KOH/g) and the valence of the polyether polyol. For example, the number average molecular weight of a polyether polyol having a hydroxy value of 56.1 mg KOH/g and a valence of 2 can be calculated to be 2,000.

Number average molecular weight=56.1×1,000×valence÷hydroxy value (3)

Examples of polyisocyanates to be reacted with the polyether polyol include pentamethylene diisocyanate, hexamethylene diisocyanate, isophorone diisocyanate, 2,4-tolylene diisocyanate, 2,6-tolylene diisocyanate, xylylene diisocyanate, diphenylmethane diisocyanate, or trimeric compounds (isocyanurate) or polymeric compounds of these polyisocyanates, allophanate type polyisocyanates, burette type polyisocyanates, and water-dispersing type polyisocyanates. These polyisocyanates may be used alone or two or more thereof may be used in combination.

Among the polyisocyanates, a bifunctional isocyanate (diisocyanate) having two isocyanate groups is preferable because it has high compatibility with the first polyether and physical properties such as viscosity are easily adjusted. It is more preferable to contain at least one selected from the group consisting of hexamethylene diisocyanate, isophorone diisocyanate, 2,4-tolylene diisocyanate, 2,6-tolylene diisocyanate, xylylene diisocyanate, and diphenylmethane diisocyanate. Xylene diisocyanate is more preferable.

In the step of reacting a polyether polyol with a polyisocyanate, the isocyanate index is preferably in a range of 1.0 or more and less than 1.2. When the isocyanate index is within this range, the amount of the first polyether having less than two isocyanate groups is in excess compared to the first polyether having two or more isocyanate groups. Therefore, when a first polyether and a first polycarbonate polyol having at least two hydroxyl groups are mixed, and isocyanate groups of the first polyether is reacted with hydroxyl groups of the first polycarbonate diol, a urethane reactive emulsifier in which the first polyether and the first polycarbonate polyol are bonded at a ratio of 1:1 via a urethane bond is obtained. Here, the isocyanate index indicates a value ratio ([NCO]/[OH]) of the number of moles of isocyanate groups in an isocyanate compound to the number of moles of hydroxyl groups in a polyol compound.

The first polyether obtained by reacting a polyether polyol with a polyisocyanate has a structure in which hydroxyl groups and isocyanate groups are reacted with each other to link them via urethane bonds. The number average molecular weight is preferably 1,000 to 50,000 and more preferably 1,200 to 30,000.

The number average molecular weight of the first polyether can be calculated using standard polystyrene molecular weight conversion or the hydroxy value (mg KOH/g) and the valence. The number average molecular weight in terms of polystyrene molecular weight can be measured using high performance liquid chromatography. Measurement can be performed using, for example, a high-speed GPC device (product name: HLC-8220GPC, commercially available from Tosoh Corporation) with two columns (Shodex GPCLF-804, molecular weight exclusion limit: 2×10⁶, separation range: 3×10² to 2×10⁶) in series. When the hydroxy value and the valence are used, the number average molecular weight can be calculated by the following formula. For example, the number average molecular weight of a polyol with 56.1 mg KOH/g and a valence of 2 can be calculated to be 2,000.

Number average molecular weight=56.1×1,000×valence÷hydroxy value

The number average molecular weight of the first polyether can be adjusted by changing the number average molecular weight of the polyether polyol or polyisocyanate used or by changing the reaction temperature, the reaction time or the like in the step of reacting a polyether polyol with a polyisocyanate.

The first polycarbonate polyol has at least two hydroxyl groups. In addition, the first polycarbonate polyol is preferably a polycarbonate polyol containing a polycarbonate structure represented by Formula (1). Examples of first polycarbonate polyols include reaction products of polyhydric alcohols and phosgene, and ring-opening polymers of cyclic carbonates (alkylene carbonates, etc.).

Examples of polyhydric alcohols include propylene glycol, dipropylene glycol, trimethylene glycol, 1,4-tetramethylenediol, 1,3-tetramethylenediol, 2-methyl-1,3-trimethylenediol, 1,5-pentamethylenediol, neopentyl glycol, 1,6-hexamethylenediol, 3-methyl-1,5-pentamethylenediol, 2,4-diethyl-1,5-pentamethylenediol, glycerin, trimethylolpropane, trimethylolethane, cyclohexanediols (1,4-cyclohexanediol, etc.), and sugar alcohols (xylitol, sorbitol, etc.).

Examples of alkylene carbonates include trimethylene carbonate, tetramethylene carbonate, and hexamethylene carbonate.

The number average molecular weight of the first polycarbonate polyol is preferably 500 to 10,000 and more preferably 700 to 8,000. If the number average molecular weight is 500 or more, when the domain has a polyether structure represented by Formula (2), the incompatibility with the domain is secured, and the phase separation between the matrix and the domain can be made clearer. In addition, when the number average molecular weight is 10,000 or less, it is possible to prevent the viscosity of the first polycarbonate polyol from excessively increasing.

The number average molecular weight of the first polycarbonate polyol can be calculated by the same method as the above method for calculating the number average molecular weight of the polyether polyol.

As the second polycarbonate polyol used in the step (ii), the polycarbonate polyols listed for the first polycarbonate polyol can be used. As described above, the first polycarbonate polyol and the second polycarbonate polyol may have the same chemical composition, or may be different from each other.

The amounts of the first polyether and the first polycarbonate polyol used are not particularly limited, and may be any amount at which droplets 54 can be dispersed in the second polycarbonate polyol 55 to form clear domains. For example, the ratio between the first polyether and the first polycarbonate polyol based on the mass is preferably 10:90 to 50:50, and more preferably 15:85 to 45:55.

As the polyisocyanate 56 having at least two isocyanate groups used in the step (iii), the same polyisocyanate as those reacted with polyether polyol exemplified as raw materials for the first polyether can be used. These polyisocyanates may be used alone or two or more thereof may be used in combination.

As the polyisocyanate 56, among the polyisocyanates exemplified above, in order to increase the elastic modulus of the matrix, it is preferable to include a polyisocyanate having at least three isocyanate groups such as a trimeric compound (isocyanurate) or polymeric compound of a polyisocyanate, an allophanate type polyisocyanate, and a burette type polyisocyanate.

It is more preferable to include at least one selected from the group consisting of a trimeric compound (isocyanurate) of pentamethylene diisocyanate, a trimeric compound (isocyanurate) of hexamethylene diisocyanate, a polymeric compound of diphenylmethane diisocyanate, and polymeric MDI.

Among the above examples, polymeric MDI is preferable. Here, polymeric MDI is a mixture of monomeric MDI and a high-molecular-weight polyisocyanate, and is represented by the following Formula (A). In Formula (A), n is preferably from 0 to 4.

As the polymeric MDI, commercially available products may be used, and examples thereof include Millionate MR series (commercially available from Tosoh Corporation) such as Millionate MR200 (product name).

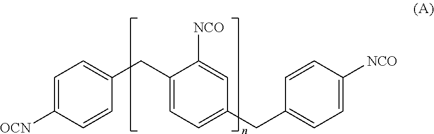

As the polyisocyanate 56 having at least two isocyanate groups, it is preferable to use a polyisocyanate having at least three isocyanate groups such as polymeric MDI in combination with a bifunctional isocyanate having two isocyanate groups. According to the above combination, the crosslink density of the matrix can be adjusted, and thus the combination is preferable because both a low hardness and a low compression set are achieved.

The amounts of the polyisocyanate having at least three isocyanate groups and the bifunctional isocyanate having two isocyanate groups are not particularly limited. The ratio of the amounts of bifunctional isocyanate:polyisocyanate having at least three isocyanate groups when mixed into the dispersion in the step (iii) is preferably 3:1 to 1:10, and more preferably 1:1 to 1:6. The amount of polyisocyanate per 100 parts by mass of the dispersion in the step (iii) is not particularly limited, and may be, for example, 1 to 10 parts by mass, or 3 to 8 parts by mass.

As the catalyst, known urethanization catalysts and isocyanuration catalysts (isocyanate trimerization catalysts) can be used. These may be used alone or in combination.

Examples of urethanization catalysts include tin-based urethanization catalysts such as dibutyltin dilaurate and stannous octoate, and amine-based urethanization catalysts such as triethylenediamine, tetramethylguanidine, pentamethyldiethylenetriamine, diethyl imidazole, tetramethylpropanediamine, N,N,N′-trimethylaminoethylethanolamine, and 1,4-diazabicyclo[2.2.2]octane-2-methanol. These may be used alone or in combination. Among these urethanization catalysts, triethylenediamine and 1,4-diazabicyclo[2.2.2]octane-2-methanol are preferable because they particularly accelerate the urethane reaction.

Examples of isocyanuration catalysts include metal oxides such as Li₂O and (Bu₃Sn)₂O, hydride compounds such as NaBH₄, alkoxide compounds such as NaOCH₃, KO-(t-Bu), and borate, amine compounds such as N(C₂H₅)₃, N(CH₃)₂CH₂C₂H₅, and 1,4-ethylenepiperazine (DABCO), alkaline carboxylate compounds such as HCOONa, Na₂CO₃, PhCOONa/DMF, CH₃COOK,(CH₃COO)₂Ca, alkaline soap, and naphthenate, alkaline formate compounds, and quaternary ammonium salt compounds such as ((R)₃—NR′OH)—OCOR″. Here, Bu represents a butyl group, Ph represents a phenyl group, R, R′ and R″ represent any alkyl group.

In addition, examples of combined catalysts (cocatalysts) used as isocyanuration catalysts include amine/epoxide, amine/carboxylic acid, and amine/alkyleneimide. These isocyanuration catalysts and combined catalysts may be used alone or in combination.

As a catalyst for urethane synthesis, N,N,N′-trimethylaminoethylethanolamine (hereinafter referred to as ETA), which acts alone as a urethanization catalyst and also acts as an isocyanuration catalyst may be used.

In the method for producing a urethane elastomer, as necessary, a chain extension agent (multifunctional low-molecular-weight polyol) may be used. Examples of chain extension agents include a glycol having a number average molecular weight of 1,000 or less. Examples of glycols include ethylene glycol (EG), diethylene glycol (DEG), propylene glycol (PG), dipropylene glycol (DPG), 1,4-butanediol (1,4-BD), 1,6-hexanediol (1,6-HD), 1,4-cyclohexanediol, 1,4-cyclohexane dimethanol, xylylene glycol (terephthalyl alcohol), and triethylene glycol.

In addition, examples of chain extension agents other than glycols include trihydric or higher polyhydric alcohols. Examples of trihydric or higher polyhydric alcohols include trimethylolpropane, glycerin, pentaerythritol, and sorbitol. These may be used alone or in combination.

### (Method for Producing Elastic Layer)

The elastic layer can be formed, for example, by performing the reacting step in the step (iii) in the above method for producing a urethane elastomer on the circumferential surface of the shaft core. Here, the other conditions to be used can be the same as those in the method for producing a urethane elastomer.

Specifically, for example, a method for preparing a mixture containing the dispersion prepared in the step (ii) and a polyisocyanate having at least two isocyanate groups and curing it on the circumferential surface of a shaft core may be exemplified. That is, the method for producing an elastic layer is, for example, a method including the following steps (2-i) to (2-iv).

Step (2-i): a step of obtaining a urethane reactive emulsifier having at least two hydroxyl groups by reacting a first polyether having at least one isocyanate group with a first polycarbonate polyol having at least two hydroxyl groups.

Step (2-ii): a step of mixing the urethane reactive emulsifier and a second polycarbonate polyol to obtain a dispersion in which droplets containing at least a part of the urethane reactive emulsifier is dispersed in the second polycarbonate polyol.

Step (2-iii): a step of mixing the dispersion obtained in the step (2-ii) and a polyisocyanate having at least two isocyanate groups to obtain an elastic layer-forming mixture.

Step (2-iv): a step of reacting the urethane reactive emulsifier, the second polycarbonate polyol, and the polyisocyanate having at least two isocyanate groups in the elastic layer-forming mixture on the circumferential surface of a shaft core.

As a method for curing the elastic layer-forming mixture on the circumferential surface of the shaft core, for example, a method (cast molding method) in which the material for the elastic layer, including the elastic layer-forming mixture, is injected into a mold in which a cylindrical pipe, a piece for holding the shaft core, and the shaft core are disposed, and thermally cured can be used. In addition, a method in which the material for the elastic layer, including the elastic layer-forming mixture, is applied onto the circumferential surface of the shaft core to form a coating film, and the coating film is heated and cured can also be used.

In addition, it is preferable to additionally perform aging after the elastic layer-forming mixture is cured on the circumferential surface of the shaft core.

### <Electrophotographic Image Forming Apparatus>

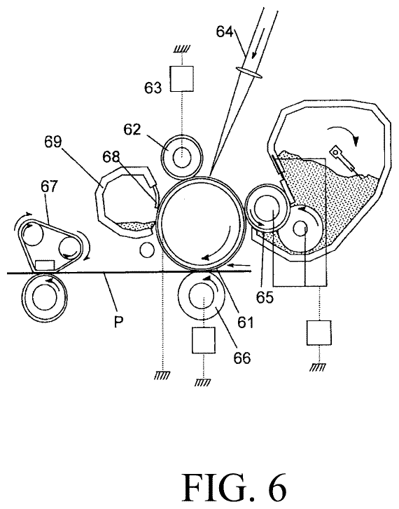

FIG. 6 shows a schematic configuration of an example of an electrophotographic image forming apparatus including an electrophotographic member according to one embodiment of the present disclosure.

In FIG. 6, the image forming apparatus includes a photosensitive member 61, a charging apparatus, a latent image forming apparatus, a developing apparatus, a transfer apparatus, a cleaning apparatus, and a fixing apparatus.

The photosensitive member 61 is a rotating drum having a photosensitive layer on a conductive substrate. The photosensitive member 61 is driven to rotate in the arrow direction at a predetermined circumferential speed (process speed).

The charging apparatus has a function of charging the photosensitive member 61, and includes a contact type charging roller 62 that is brought into contact and placed in contact with the photosensitive member 61 by applying a predetermined pressing force. The charging roller 62 rotates in the arrow direction as the photosensitive member 61 rotates. The charging roller 62 charges the photosensitive member 61 to a predetermined potential by applying a predetermined DC voltage from a charging power source 63.

The latent image forming apparatus (not shown) performs exposure to form an electrostatic latent image on the photosensitive member 61. As the latent image forming apparatus, an exposure apparatus such as a laser beam scanner is used. The latent image forming apparatus forms an electrostatic latent image by emitting exposure light 64 corresponding to image information to the uniformly charged photosensitive member 61.

The developing apparatus has a function of developing a toner image, and includes a developing roller 65 that is disposed adjacent to or in contact with the photosensitive member 61. The developing roller 65 develops the electrostatic latent image by reversal development using a toner that has been electrostatically treated to have the same polarity as the charge polarity of the photosensitive member 61, and forms a toner image on the photosensitive member 61.

The transfer apparatus has a function of transferring the developed toner image onto a recording material P, and includes a contact type transfer roller 66. The transfer roller 66 rotates in the arrow direction as the photosensitive member 61 rotates, and transfers the toner image from the photosensitive member 61 onto the recording material P such as plain paper. Here, the recording material P is transported in the arrow direction by a paper feed system (not shown) having a transport member.

The cleaning apparatus has a function of collecting the transfer residual toner on the photosensitive member 61, and includes a blade type cleaning member 68 and a collection container 69. The cleaning apparatus mechanically scrapes off and collects the transfer residual toner remaining on the photosensitive member 61 after the toner image is transferred onto the recording material P.

Here, when a simultaneous development and cleaning system in which the developing apparatus collects the transfer residual toner is used, it is possible to omit the cleaning apparatus.

The fixing apparatus has a function of fixing a toner image, and is composed of a fixing belt 67 having a heated roller, and fixes the toner image transferred onto the recording material P according to rotation in the arrow direction, and discharges the recording material P outside the apparatus.

In the image forming apparatus, the above electrophotographic member can be suitably used as the charging roller 62 or the developing roller 65. That is, the electrophotographic image forming apparatus can include the electrophotographic member of the present disclosure.

### <Process Cartridge>

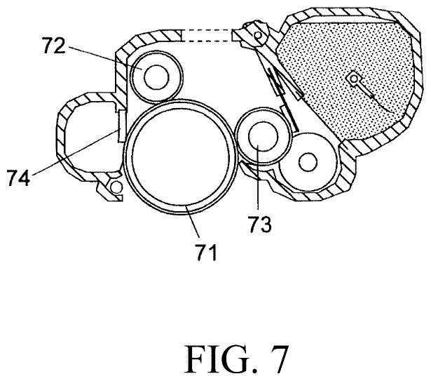

FIG. 7 shows a schematic configuration of one embodiment of a process cartridge according to one embodiment of the present disclosure. The process cartridge integrates a photosensitive member 71, a charging roller 72, a developing roller 73, and a cleaning member 74, and is detachable from the main body of the electrophotographic image forming apparatus. The process cartridge includes the above electrophotographic member according to one embodiment of the present disclosure, and such an electrophotographic member can be particularly suitably used as the charging roller 72 or the developing roller 73.

That is, the process cartridge is a process cartridge detachable from the main body of the electrophotographic image forming apparatus, and may be a process cartridge including the electrophotographic member of the present disclosure.

### EXAMPLES

One embodiment of the present disclosure will be described below in more detail with reference to examples. However, the present disclosure is not limited to the following examples.

### Example 1

### (Preparation of Elastic Layer-Forming Mixture)

11.2 parts by mass of polypropylene glycol (product name: UNIOL D-4000, commercially available from NOF Corporation), 5.6 parts by mass of polypropylene glycol (product name: UNIOL D-2000, commercially available from NOF Corporation), 1.1 parts by mass of xylylene diisocyanate (XDI) (commercially available from Tokyo Chemical Industry Co., Ltd.) and 500 ppm of 1,4-diazabicyclo[2.2.2]octane-2-methanol (product name: RZETA, commercially available from Tosoh Corporation) as a curing catalyst were put into a closed mixer, and the mixture was stirred for 4 hours in the closed mixer adjusted to 100° C. to synthesize a first polyether having at least one isocyanate group. Here, the isocyanate index in this case was 1.1.

Here, in the following examples and comparative examples, the amount of the curing catalyst is expressed in ppm by mass based on the mass of the elastic layer-forming mixture excluding the curing catalyst.

70.0 parts by mass of polycarbonate diol (product name: Kuraray Polyol C-2065N, commercially available from Kuraray Co., Ltd.) was mixed therewith. Then, the mixture was additionally stirred for 2 hours in a closed mixer adjusted to 100° C. to synthesize a urethane reactive emulsifier having two hydroxyl groups (step (2-i)), and a dispersion in which droplets containing at least a part of the urethane reactive emulsifier were dispersed in the polycarbonate diol was obtained (step (2-ii)).

2.8 parts by mass of xylylene diisocyanate (commercially available from Tokyo Chemical Industry Co., Ltd., hereinafter sometimes referred to as “XDI”), 7.4 parts by mass of polyisocyanate (product name: Millionate MR-200, commercially available from Tosoh Corporation, hereinafter sometimes referred to as “MR-200”), and 1.8 parts by mass of an ion conducting agent (product name CIL-542: commercially available from Japan Carlit Co., Ltd., hereinafter sometimes referred to as “CIL”) were added to the dispersion, and the mixture was stirred using a rotation and revolution vacuum defoaming mixer for 2 minutes under conditions of a rotational speed of 800 rpm and a revolution speed of 1,600 rpm to obtain an elastic layer-forming mixture (step (2-iii)).

### (Preparation of Electrophotographic Roller)

A primer (product name: Metaloc N-33, commercially available from Toyokagaku Kenkyusho Co., Ltd.) was applied to a SUS304 shaft core with a diameter of 6 mm and a length of 250 mm and baked at 130° C. for 30 minutes. Next, this shaft core was placed concentrically in a cylindrical mold with an inner diameter of 11.5 mm, and the elastic layer-forming mixture was injected into the cylindrical mold preheated to 130° C. over 10 seconds.

The cylindrical mold was heated at 130° C. for 1 hour, the mold was then removed, and aging was additionally performed at 80° C. for 2 days to obtain an elastic layer (step 2-iv). The ends of the elastic layer were additionally removed to obtain an electrophotographic roller with a length of 225 mm and an elastic layer thickness of 2.0 mm. The obtained electrophotographic roller was subjected to the following evaluations.

### (Measurement of Current of Electrophotographic Roller)

For the measurement, the electrophotographic roller was left in an environment at a temperature of 23° C. for 24 hours or longer, and the measurement was performed using an electrophotographic roller current measurement device left in the same environment. The obtained electrophotographic roller was placed in contact with a metal drum with a diameter of 50 mm by applying a load of 4.9 N to both ends of the shaft core. The metal drum was rotated at a surface speed of 50 mm/sec, and the electrophotographic roller was rotated in a driven manner. A resistor having a known electrical resistance that is two or more orders of magnitude lower than the electrical resistance of the electrophotographic roller was connected between the metal drum and the ground. A voltage of +50 V was applied to the shaft core of the electrophotographic roller from a high-voltage power source HV, and the potential difference between both ends of the resistor was measured using a digital multimeter (product name: CDM-2000D, commercially available from CUSTOM Corporation). In the measurement using the digital multimeter, 2 seconds after the voltage was applied, sampling was performed for 3 seconds, and the value calculated from the average value thereof was the potential difference of the electrophotographic roller. From the measurement value of the potential difference and the electrical resistance of the resistor, the current flowing through the electrophotographic roller to the metal drum was calculated to be A.

### <Method for Evaluating Electrophotographic Roller>

### (Evaluation 1: Confirmation and Analysis of Matrix and Domain)

Using a cryo-microtome system (product name: EM FC6, commercially available from Leica Microsystems) and an ultramicrotome (product name: EM UC6, commercially available from Leica Microsystems), ultrathin sections (500 μm×500 μm×5 μm) were prepared from the elastic layer of the electrophotographic roller. The locations for preparing sections were a total of three locations including the center of the elastic layer in the longitudinal direction and two locations of L/4 from both ends of the elastic layer toward the center when the length of the elastic layer in a longitudinal direction is L, and sections of the elastic layer having an exposed cross section in which the domain and the matrix were exposed in the thickness direction were prepared.

Mapping measurement was performed on the prepared sections using an infrared microscope imaging system (product name: Spectrum400 (spectrometer) and Spotlight 400 (scanning device, commercially available from PerkinElmer Co., Ltd.) to create mapping images. For the measurement, mapping measurement was performed using ATR imaging accessories under conditions: pixel size: 1.56 m, resolution: 16 cm⁻¹, field of view: 300 μm×300 μm, and scanning speed: 1.0 cm/s. The mapping image is an image of the magnitude of the integrated value of the infrared absorption spectrum for each pixel. The presence of the matrix and the domain was confirmed from the obtained mapping image. In addition, it was confirmed that the matrix had a structure corresponding to polycarbonate diol from the infrared absorption spectrum of the matrix of the mapping image. In addition, it was confirmed that the domain had a structure corresponding to polypropylene glycol from the infrared absorption spectrum of the domain of the mapping image. That is, it was confirmed that the matrix had a carbonate structure represented by Formula (1), and the domain had an ether structure represented by Formula (2).

### (Evaluation 2: Measurement of Micro Rubber Hardness)

The micro rubber hardness of the elastic layer was measured using a micro rubber hardness meter (product name: MD-1capa, commercially available from Kobunshi Keiki Co., Ltd.). For the measurement, the electrophotographic roller was left in an environment at a temperature of 23° C. for 24 hours or longer, and the measurement was performed using a measurement device left in the same environment. In addition, the push pin used was a type A (push pin shape: a height of 0.50 mm, a diameter of 0.16 mm, cylindrical, a pressure leg size: an outer diameter of 4 mm, an inner diameter of 1.5 mm), and the measurement mode was a peak hold mode.

The locations for measuring the micro rubber hardness were a total of three locations including the center of the elastic layer in the longitudinal direction and two locations of L/4 from both ends of the elastic layer toward the center when the length of the elastic layer in a longitudinal direction is L. The micro rubber hardness was measured once at each measurement location at a temperature of 23° C.

### (Evaluation 3: Measurement of Parameter Indicating Viscoelasticity Term)

In the same manner as in Evaluation 1, from a total of three locations including the center of the elastic layer in the longitudinal direction and two locations of L/4 from both ends of the elastic layer toward the center, ultrathin sections having a cross section in which the domain and the matrix were exposed were prepared.

An arbitrary square observation region with a side of 50 μm was selected in the thickness region from the outer surface of each section to a position of a depth of 100 μm, and in a total of three observation regions, the viscoelasticity image was measured using a scanning probe microscope (product name: S-Image, commercially available from SII NanoTechnology Inc.). The viscoelasticity image measurement mode was VE-DFM. In addition, as the cantilever, “SI-DF3” (product name, commercially available from Hitachi High-Tech Science Corporation, spring constant=1.9 N/m) was used. In addition, the scanning frequency was 0.5 Hz.

From the obtained viscoelasticity image, in each observation region, the parameters indicating the viscoelasticity term were calculated for 10 points each for the matrix and the domain, and the parameter A (mV) indicating the viscoelasticity term of the domain and the parameter B (mV) indicating the viscoelasticity term of the matrix were calculated from their arithmetic average values.

Here, it was confirmed from the viscoelasticity image taken by SPM that the domain was exposed and the matrix was exposed in the cross section.

### (Evaluation 4: Elastic Modulus of Matrix)

In the same manner as in Evaluation 1, from a total of three locations including the center of the elastic layer in the longitudinal direction and two locations of L/4 from both ends of the elastic layer toward the center, ultrathin sections having an exposed cross section in which the domain and the matrix were exposed prepared.

A square observation region with a side of 50 μm was set at an arbitrary position in the thickness region from the outer surface of the elastic layer of each section to a position of a depth of 100 μm. Thus, in a total of three observation regions, the phase image was observed using a scanning probe microscope (product name: MFP-3D-Origin, commercially available from Oxford Instruments). The phase image measurement mode was AM-AFM. In addition, as the cantilever, “OMCL-AC-160TS” (product name, commercially available from Olympus Corporation, spring constant=47.08 N/m) was used. In addition, the scanning frequency was 0.5 Hz.

From the obtained phase image, the elastic modulus of the matrix was obtained by measuring a force curve using the scanning probe microscope. The force curve measurement mode was a contact mode, Force Distance was 500 nm, and Trigger Point was 0.01 V.

In addition, as the cantilever, “OMCL-AC-160TS” (product name, commercially available from Olympus Corporation, spring constant=47.08 N/m) was used. In addition, the scanning frequency was 1 Hz.

In each observation region, the elastic modulus of the matrix was determined at 10 points, and the arithmetic average value thereof was calculated.

Here, it was confirmed from the phase image taken by SPM that the domain was exposed and the matrix was exposed in the cross section.

### (Evaluation 5: Measurement of Circularity and Number of Domains)

Each of the three viscoelasticity images obtained in Evaluation 3 was converted into a 256-gradation grayscale image using image processing software (product name: ImageProPlus, commercially available from Media Cybernetics, Inc.), and then binarized to obtain a binarized image for analysis. The threshold value for binarization was determined from the monochrome image brightness distribution based on the Otsu's algorithm described in IEEE Transactions on SYSTEMS, MAN, AND CYBERNETICS, Vol. SMC-9, No. 1, January 1979, pp. 62-66.

In addition, from the obtained binarized image, the circularity and average circularity of the domain were calculated using the count function of the image processing software. However, among the domains determined by the count function, domains with a cross-sectional area of less than 0.05 area % in the observation region of 50 m squares were considered as noise and removed from data. Thus, among the domains in each observation region, the number of domains with a circularity of 0.60 to 0.95 was counted, and the proportion (%) of the number of domains with a circularity of 0.60 to 0.95 based on the total number of domains in each observation region was calculated.

(Evaluation 6: Measurement of Recovery of Elastic Layer from Deformation)

The recovery of the elastic layer from deformation was evaluated by an indentation test using a nanoindenter (product name: HM2000, commercially available from Fischer Instruments K.K.) at a temperature of 23° C. For the measurement, the electrophotographic roller was left in an environment at a temperature of 23° C. for 24 hours or longer, and the measurement was performed using a measurement device left in the same environment.

The measurement locations were a total of three locations including the center of the elastic layer in the longitudinal direction and two locations of L/4 from both ends of the elastic layer toward the center when the length of the elastic layer in a longitudinal direction is L. In the indentation test, a Vickers indenter was brought into contact with the matrix at the outer surface of the elastic layer, the Vickers indenter (square pyramid shape, facing angle 136°) was pressed into the elastic layer at a load rate of 10 mN/30 seconds, and a load of 10 mN was maintained for 60 seconds. Then, unloading was performed at an unload rate of 10 mN/sec, and the strain 5 seconds after unloading was completed was measured once at each measurement location.

### (Evaluation 7: Measurement of Cross-sectional Area and Number of Domains)

From the binarized image obtained in Evaluation 5, the cross-sectional area of the domain, the number of domains, and the average cross-sectional area of the domains were calculated using the count function of the image processing software. However, in the same manner as in Evaluation 5, noise was removed from data. Thus, the proportion (area %) of the total cross-sectional area of the domain in each observation region relative to the area of the observation region was calculated.

In addition, among the domains in each observation region, the number of domains having a cross-sectional area that was 0.10 to 13.00 area % of the area of the observation region was determined, and the proportion (area %) of the number of domains having a cross-sectional area of 0.10 to 13.00 area % relative to the area of the observation region was determined.

### (Evaluation 8: Evaluation of Streaky Image Defects and Toner Adhesion)

A color laser printer (product name: LBP7700C, commercially available from Canon Inc.) and a process cartridge incorporating an electrophotographic roller as a developing roller were allowed to acclimate to an environment at a temperature of 30° C. and a humidity of 80% RH for 24 hours, and the image was then evaluated.

Specifically, the process cartridge incorporating an electrophotographic roller as a developing roller was installed in the color laser printer. Thus, ten sheets of halftone images (images in which horizontal lines with a width of 1 dot and an interval of 2 dots were drawn in a direction perpendicular to the rotation direction of the photosensitive member) were consecutively output, and the obtained images were visually observed to determine streaky image defects according to the following criteria.

In addition, after the ten sheets were consecutively output, the developing roller was taken out, air was blown, the toner fixed to the developing roller was visually observed, and toner adhesion was determined according to the following criteria.

### <Evaluation of Streaky Image Defects 8-1>

Rank A: No streaky image defects were observed from the first sheet onwards.
Rank B: Streaky image defects were observed only on the first sheet.
Rank C: Streaky image defects were observed from the second sheet onwards.

### <Evaluation of Toner Adhesion>

Rank A: No toner adhesion was observed on the entire electrophotographic roller.
Rank B: Toner adhesion was observed in some regions of the electrophotographic roller, but no image defects due to toner adhesion were observed.
Rank C: Toner adhesion was observed in many regions of the electrophotographic roller, and image defects due to toner adhesion were also observed.

### (Evaluation 9: Evaluation of Scraping of Ends, Toner Melt Adhesion, and Image Defects Due to Toner Melt Adhesion)

The color laser printer and the process cartridge incorporating an electrophotographic roller as a developing roller were allowed to acclimate to an environment at a temperature of 30° C. and a humidity of 80% RH for 24 hours.

Then, the electrophotographic roller as a developing roller was installed in the color laser printer, and 10,000 sheets of images in which horizontal lines with a width of 2 dots and an interval of 50 dots were drawn were consecutively output. While 10,000 sheets were consecutively output, the developing roller was taken out every 1,000 sheets, the developing roller was visually observed, and scraping of the ends of the developing roller and toner melt adhesion were determined according to the following criteria.

### <Evaluation 9-1: Evaluation of Scraping of Ends>

The number of sheets output when scraping of the ends of the developing roller was observed was taken as the number of sheets in which scraping occurred.

### <Evaluation 9-2: Evaluation of Toner Melt Adhesion>

The number of sheets output when toner melt adhesion was observed in the developing roller was taken as the number of sheets in which melt adhesion occurred.

### Examples 2 to 6, and 8 to 12

Elastic layers were formed in the same manner as in Example 1 except that the materials shown in Table 3 were used in the addition amounts shown in Table 3 to prepare elastic layer-forming mixtures, and thereby electrophotographic rollers according to examples were prepared. The obtained electrophotographic rollers were evaluated in the same manner as in Example 1.

The measurement results of the currents of the electrophotographic rollers were A, which was the same as in Example 1.

Here, the details of materials in Table 3 are shown in Table 1 and Table 2. The same applies to the following examples.

### Example 7

An elastic layer was formed in the same manner as in Example 1 except that the materials shown in Table 3 were used in the addition amounts shown in Table 3 to prepare an elastic layer-forming mixture and the elastic layer-forming mixture was injected into the cylindrical mold for 5 seconds, and thereby an electrophotographic roller according to Example 7 was prepared. The obtained electrophotographic roller was evaluated in the same manner as in Example 1.

The measurement result of the current of the electrophotographic roller was 10 A, which was the same as in Example 1.

TABLE 1

| | | Number of | |
|---|---|---|---|
| | | carbon atoms | |
| | | for R² | |
| | | in General | |
| No. | Material A | Formula (2) | Mn |
| A1 | Polypropylene glycol | 4 (branched) | 12,000 |
| | ┌PREMINOL S4013F┘ | | |
| | (product name, commercially available | | |
| | from AGC Inc.) | | |
| A2 | Polypropylene glycol | 4 (branched) | 4,000 |
| | ┌UNIOL D-4000┘ | | |
| | (product name, commercially available | | |
| | from NOF Corporation) | | |
| A3 | Polypropylene glycol | 4 (branched) | 2,000 |
| | ┌UNIOL D-2000┘ | | |
| | (product name, commercially available | | |
| | from NOF Corporation) | | |
| A4 | Polytetramethylene glycol | 4 (linear) | 2,000 |
| | ┌PTMG2000┘ | | |
| | (product name, commercially available | | |
| | from Mitsubishi Chemical Corporation) | | |
| A5 | Tetrahydrofuran-neopentyl glycol | 4 (linear) + 5 | 1,800 |
| | copolymer ┌PTXG-1800┘ | (branched) | |
| | (product name, commercially available | | |
| | from Asahi Kasei Corporation) | | |

In the table, the tetrahydrofuran-neopentyl glycol copolymer is a polyether glycol represented by HO—(CH₂CH₂CH₂CH₂O)m-(CH₂C(CH₃)₂CH₂O)n-OH. That is, regarding the number of carbon atoms of a tetrahydrofuran-neopentyl glycol copolymer, the description of 4 (linear)+5 (branched) indicates that R² includes a linear structure having 4 carbon atoms and a branched structure having 5 carbon atoms.

TABLE 2

| | | Number of | |
|---|---|---|---|
| | | carbon atoms | |
| | | for R¹ | |
| | | in General | |
| No. | Material B | Formula (1) | Mn |
| B1 | Polycarbonate diol | 3 (linear) + 4 | 2,000 |
| | ┌Duranol G3452┘ | (branched) | |
| | (product name, commercially available | | |
| | from Asahi Kasei Corporation) | | |
| B2 | Polycarbonate polyol | 6 (linear) + 6 | 2,000 |
| | ┌Kuraray polyol C-2090┘ | (branched) | |
| | (product name, commercially available | | |
| | from Kuraray Co., Ltd.) | | |
| B3 | Polycarbonate polyol | 9 (linear) + 9 | 2,000 |
| | ┌Kuraray polyol C-2065N┘ | (branched) | |
| | (product name, commercially available | | |
| | from Kuraray Co., Ltd.) | | |
| B4 | Polycarbonate diol | 6 (linear) | 2,000 |
| | ┌Duranol T6002┘ | | |
| | (product name, commercially available | | |
| | from Asahi Kasei Corporation) | | |
| B5 | Polyester polyol | — | 2,000 |
| | ┌Kuraray polyol P-2050┘ | | |
| | (product name, commercially available | | |
| | from Kuraray Co., Ltd.) | | |

In the table, Kuraray polyol C-2090 (commercially available from Kuraray Co., Ltd.) is a polycarbonate polyol having a number average molecular weight of 2,000, a hydroxy value of 56.3 mg KOH/g, and a structure corresponding to 1,6-hexanediol and a structure corresponding to 3-methyl-1,5-pentanediol. That is, regarding the number of carbon atoms of polycarbonate diol and polycarbonate polyol, for example, the description of 6 (linear)+6 (branched) indicates that R¹ includes a linear structure having 6 carbon atoms and a branched structure having 6 carbon atoms. In addition, Kuraray polyol P-2050 is a polyester polyol having a structure corresponding to adipic acid and a structure corresponding to 3-methyl-1,5-pentanediol.

TABLE 3

| | | Material A | | Material A | | Materal B | | | Parts by mass of | Parts by | | |
|---|---|---|---|---|---|---|---|---|---|---|---|---|
| | | | Parts | | Parts | | Parts | Index when | XDI when first | mass of | MR-200 | CIL-542 |
| | | | by | | by | | by | first polyether | polyether is | XDI during | Parts by | Parts by |
| | | Type | mass | Type | mass | Type | mass | is produced | produced | Step (2-iii) | mass | mass |
| Example | 1 | A2 | 11.2 | A3 | 5.6 | B3 | 70.0 | 1.1 | 1.1 | 2.8 | 7.4 | 1.8 |
| | 2 | A2 | 19.7 | A3 | 18.8 | B3 | 49.3 | 1.1 | 2.9 | 2.1 | 5.3 | 1.8 |
| | 3 | A2 | 29.6 | — | — | B2 | 58.4 | 1.1 | 1.5 | 2.1 | 6.6 | 1.8 |
| | 4 | A5 | 29.0 | — | — | B2 | 57.2 | 1.1 | 3.2 | 1.7 | 7.1 | 1.8 |
| | 5 | A1 | 20.0 | A2 | 19.1 | B2 | 50.1 | 1.1 | 1.3 | 1.9 | 5.8 | 1.8 |
| | 6 | A2 | 15.1 | A3 | 5.3 | B2 | 66.7 | 1.1 | 1.3 | 2.6 | 7.2 | 1.8 |
| | 7 | A2 | 29.6 | — | — | B2 | 58.4 | 1.1 | 1.5 | 2.1 | 6.6 | 1.8 |
| | 8 | A2 | 29.6 | — | — | B2 | 58.4 | 1.2 | 1.6 | 2.0 | 6.6 | 1.8 |
| | 9 | A3 | 17.5 | — | — | B4 | 68.3 | 1.0 | 1.6 | 1.9 | 9.0 | 1.8 |
| | 10 | A1 | 42.3 | — | — | B2 | 47.8 | 1.2 | 1.4 | 1.2 | 5.4 | 1.8 |
| | 11 | A2 | 29.5 | — | — | B5 | 58.2 | 1.2 | 1.6 | 1.8 | 7.1 | 1.8 |
| | 12 | A4 | 29.2 | — | — | B1 | 57.5 | 1.2 | 3.3 | 1.3 | 7.1 | 1.8 |

In the table, the index indicates an isocyanate index.

### Comparative Example 1

### (Preparation of Elastic Layer-Forming Mixture)

48.1 parts by mass of polypropylene glycol (product name: PREMINOL S 4013F, commercially available from AGC Inc.), 1.5 parts by mass of xylylene diisocyanate (XDI) (commercially available from Tokyo Chemical Industry Co., Ltd.), and 500 ppm of 1,4-diazabicyclo[2.2.2]octane-2-methanol (product name: RZETA, commercially available from Tosoh Corporation) as a curing catalyst were put into a closed mixer, and the mixture was stirred for 4 hours in the closed mixer adjusted to 100° C. to synthesize a polyether having two isocyanate groups. Here, the isocyanate index in this case was 1.2.

42.6 parts by mass of polycarbonate diol (product name: Kuraray Polyol C-2090, commercially available from Kuraray Co., Ltd.) was mixed therewith. Then, the mixture was additionally stirred for 2 hours in a closed mixer adjusted to 100° C. to synthesize a urethane reactive emulsifier having two hydroxyl groups, and a dispersion in which droplets containing at least a part of the urethane reactive emulsifier were dispersed in the polycarbonate diol was obtained.

0.9 parts by mass of xylylene diisocyanate (commercially available from Tokyo Chemical Industry Co., Ltd.), 5.0 parts by mass of polyisocyanate (product name: Millionate MR-200, commercially available from Tosoh Corporation), and 1.8 parts by mass of an ion conducting agent (product name: CIL-542, commercially available from Japan Carlit Co., Ltd.) were added to the dispersion, and the mixture was stirred using a rotation and revolution vacuum defoaming mixer for 2 minutes under conditions of a rotational speed of 800 rpm and a revolution speed of 1,600 rpm to obtain an elastic layer-forming mixture.

An electrophotographic roller according to Comparative Example 1 was obtained in the same manner as in Example 1 except that the elastic layer-forming mixture obtained in this manner was used. The obtained electrophotographic roller was evaluated in the same manner as in Example 1.

Regarding the results of Evaluation 1, the matrix and the domain were clearly phase-separated. In addition, it was confirmed that the matrix had a structure corresponding to polypropylene glycol, and the domain had a structure corresponding to polycarbonate diol. That is, the relationship between the domain and the matrix was reversed from that of the urethane elastomer according to Example 1.

### Comparative Example 2

### (Preparation of Elastic Layer-Forming Mixture)

42.3 parts by mass of polypropylene glycol (product name: PREMINOL S4013F, commercially available from AGC Inc.), 47.8 parts by mass of polycarbonate diol (product name: Kuraray Polyol C-2090, commercially available from Kuraray Co., Ltd.), and 500 ppm of 1,4-diazabicyclo[2.2.2]octane-2-methanol (product name: RZETA, commercially available from Tosoh Corporation) as a curing catalyst were put into a closed mixer, and the mixture was stirred for 2 hours in the closed mixer adjusted to 100° C.

2.6 parts by mass of xylylene diisocyanate (XDI) (commercially available from Tokyo Chemical Industry Co., Ltd.), 5.4 parts by mass of polyisocyanate (product name: Millionate MR-200, commercially available from Tosoh Corporation), and 1.8 parts by mass of an ion conducting agent (product name:CIL-542, commercially available from Japan Carlit Co., Ltd.) were added thereto, and the obtained mixture was stirred for 2 minutes in the closed vacuum mixer to obtain an elastic layer-forming mixture.

An electrophotographic roller according to Comparative Example 2 was prepared in the same manner as in Example 1 except that this elastic layer-forming mixture was used. The obtained electrophotographic roller was evaluated in the same manner as in Example 1.

### Comparative Example 3

### (Preparation of Elastic Layer-Forming Mixture)

46.7 parts by mass of polycarbonate diol (product name: Kuraray Polyol C-2090, commercially available from Kuraray Co., Ltd.), 44.8 parts by mass of silicone particles (product name:KMP-598, commercially available from Shin-Etsu Chemical Co., Ltd.) as soft resin particles and 500 ppm of 1,4-diazabicyclo[2.2.2]octane-2-methanol (product name: RZETA, commercially available from Tosoh Corporation) as a curing catalyst were put into a closed mixer, and the mixture was stirred for 4 hours in the closed vacuum mixer adjusted to 100° C.

2.6 parts by mass of xylylene diisocyanate (XDI) (commercially available from Tokyo Chemical Industry Co., Ltd.), 84.2 parts by mass of polyisocyanate (product name: Millionate MR-200, commercially available from Tosoh Corporation), and 1.8 parts by mass of an ion conducting agent (product name: CIL-542, commercially available from Japan Carlit Co., Ltd.) were added thereto. The obtained mixture was stirred using a rotation and revolution vacuum defoaming mixer for 2 minutes under conditions of a rotational speed of 800 rpm and a revolution speed of 1,600 rpm to obtain an elastic layer-forming mixture.

An elastic layer was formed in the same manner as in Example 1 except that this elastic layer-forming mixture was used, and thereby an electrophotographic roller according to Comparative Example 3 was prepared. The obtained electrophotographic roller was evaluated in the same manner as in Example 1. Here, in the evaluation of the electrophotographic roller according to this comparative example, silicone particles were regarded as domains for evaluation.

### Comparative Example 4

### (Preparation of Elastic Layer-Forming Mixture)

100.0 parts by mass of NBR (product name: N230SV, commercially available from JSR Corporation), 50.0 parts by mass of carbon black (product name: Toka Black #7360, commercially available from Tokai Carbon Co., Ltd.), 70.0 parts by mass of calcium carbonate (product name: NANOX #30, commercially available from Maruo Calcium Co., Ltd.), 7.0 parts by mass of zinc oxide (product name: zinc oxide, commercially available from Sakai Chemical Industry Co., Ltd.), and 2.8 parts by mass of zinc stearate (product name:SZ-2000, commercially available from Sakai Chemical Industry Co., Ltd.) were mixed in a pressure type kneader for 16 minutes under conditions of a filling rate of 70 vol % and a blade rotation speed of 30 rpm to obtain a matrix-forming unvulcanized rubber.

Next, 100.0 parts by mass of SBR (product name: TUFDENE 2003, commercially available from Asahi Kasei Corporation), 5.0 parts by mass of zinc oxide (product name: zinc oxide, commercially available from Sakai Chemical Industry Co., Ltd.), and 2.0 parts by mass of zinc stearate (product name:SZ-2000, commercially available from Sakai Chemical Industry Co., Ltd.) were mixed in a pressure type kneader for 16 minutes under conditions of a filling rate of 70 vol % and a blade rotation speed of 30 rpm to obtain a domain-forming unvulcanized rubber.

In addition, 65.0 parts by mass of the matrix-forming unvulcanized rubber and 35.0 parts by mass of the domain-forming unvulcanized rubber were mixed in a pressure type kneader for 16 minutes under conditions of a filling rate of 70 vol % and a blade rotation speed of 30 rpm to obtain an unvulcanized rubber mixture.

100.0 parts by mass of the obtained unvulcanized rubber mixture, 3.0 parts by mass of sulfur (product name: SULFAX PMC, commercially available from Tsurumi Chemical Industry Co., Ltd.), and 2.0 parts by mass of tetrabenzyl thiuram disulfide (product name: TBZTD, commercially available from Sanshin Chemical Industry Co., Ltd.) were turned left and right a total of 20 times using an open roll at a front roll rotation speed of 10 rpm, a rear roll rotation speed of 8 rpm, and a roll gap of 2 mm, and then tightly passed 10 times at a roll gap of 0.5 mm to obtain an elastic layer-forming mixture.

### (Preparation of Electrophotographic Roller)

A primer (product name: Metaloc N-33, commercially available from Toyokagaku Kenkyusho Co., Ltd.) was applied to a SUS304 shaft core with a diameter of 6 mm and a length of 250 mm and baked at 130° C. for 30 minutes.

Next, a die with an inner diameter of 14.0 mm was attached to a tip of a crosshead extruder having a shaft core supply mechanism and an unvulcanized rubber roller discharge mechanism and the crosshead extruder was preheated to 80° C. The transport speed of the shaft core was adjusted to 60 mm/sec, the elastic layer-forming mixture was supplied from the extruder, and the outer circumferential part of the shaft core was covered with the elastic layer-forming mixture in the crosshead to obtain an unvulcanized rubber roller.

The obtained unvulcanized rubber roller was heated in a hot air vulcanizing furnace at 170° C. for 60 minutes to obtain a roller in which the elastic layer was formed on the outer circumferential part of the shaft core. Then, the ends of the elastic layer were removed, and the surface of the elastic layer was polished with a rotary grindstone to obtain an electrophotographic roller with a length of 225 mm and an elastic layer thickness of 2.0 mm.

The obtained electrophotographic roller was evaluated in the same manner as in Example 1.

The evaluation results of Examples 1 to 12 and Comparative Examples 1 to 4 are shown in Table 4-1 to Table 4-2 and Table 5.

TABLE 4-1

| | | | | | | Evaluation 5 | |
|---|---|---|---|---|---|---|---|
| | | | | | | | Proportion of |
| | | | | | | | number of |
| | | | | | Evaluation 4 | | domains |
| | Evaluation 1 | Evaluation 2 | | | Elastic | | having a |
| | Confirmation and | Micro | Evaluation 3 | Evaluation 3 | modulus | Average | circularity of |
| | analysis of | rubber | A | B | of matrix | circularity | 0.60 to 0.95 |
| | matrix and domain | hardness | (mV) | (mV) | (MPa) | of domains | (number %) |
| Example | Clear phase separation | 42 | 100 | 450 | 23 | 0.95 | 90 |
| 1 | between M and D | | | | | | |
| | M: Structure derived from | 42 | 100 | 450 | 23 | 0.95 | 90 |
| | polycarbonate urethane | | | | | | |
| | D: Structure derived from | 42 | 100 | 450 | 23 | 0.95 | 90 |
| | PPG | | | | | | |
| Example | Same as above | 40 | 100 | 450 | 23 | 0.95 | 90 |
| 2 | | 40 | 100 | 450 | 23 | 0.95 | 90 |
| | | 40 | 100 | 450 | 23 | 0.95 | 90 |
| Example | Same as above | 37 | 80 | 350 | 16 | 0.95 | 90 |
| 3 | | 37 | 80 | 350 | 16 | 0.95 | 90 |
| | | 37 | 80 | 350 | 16 | 0.95 | 90 |
| Example | Clear phase separation | 37 | 85 | 350 | 16 | 0.95 | 90 |
| 4 | between M and D | | | | | | |
| | M: Structure derived from | 37 | 85 | 350 | 16 | 0.95 | 90 |
| | polycarbonate urethane | | | | | | |
| | D: Structure derived from | 37 | 85 | 350 | 16 | 0.95 | 90 |
| | tetrahydrofuran-neopentyl | | | | | | |
| | glycol copolymer | | | | | | |
| Example | Clear phase separation | 33 | 60 | 350 | 16 | 0.95 | 90 |
| 5 | between M and D | | | | | | |
| | M: Structure derived from | 33 | 60 | 350 | 16 | 0.95 | 90 |
| | polycarbonate urethane | | | | | | |
| | D: Structure derived from | 33 | 60 | 350 | 16 | 0.95 | 90 |
| | PPG | | | | | | |
| Example | Same as above | 40 | 100 | 350 | 16 | 0.95 | 90 |
| 6 | | 40 | 100 | 350 | 16 | 0.95 | 90 |
| | | 40 | 100 | 350 | 16 | 0.95 | 90 |
| Example | Same as above | 37 | 80 | 350 | 16 | 0.60 | 70 |
| 7 | | 37 | 80 | 350 | 16 | 0.60 | 70 |
| | | 37 | 80 | 350 | 16 | 0.60 | 70 |
| Example | Same as above | 34 | 80 | 290 | 12 | 0.95 | 90 |
| 8 | | 34 | 80 | 290 | 12 | 0.95 | 90 |
| | | 34 | 80 | 290 | 12 | 0.95 | 90 |
| Example | Same as above | 50 | 140 | 620 | 35 | 0.95 | 90 |
| 9 | | 50 | 140 | 620 | 35 | 0.95 | 90 |
| | | 50 | 140 | 620 | 35 | 0.95 | 90 |
| Example | Same as above | 32 | 60 | 260 | 11 | 0.95 | 90 |
| 10 | | 32 | 60 | 260 | 11 | 0.95 | 90 |
| | | 32 | 60 | 260 | 11 | 0.95 | 90 |
| Example | Clear phase separation | 30 | 80 | 250 | 9 | 0.95 | 90 |
| 11 | between M and D | | | | | | |
| | M: Structure derived from | 30 | 80 | 250 | 9 | 0.95 | 90 |
| | polyester urethane | | | | | | |
| | D: Structure derived from | 30 | 80 | 250 | 9 | 0.95 | 90 |
| | PPG | | | | | | |
| Example | Clear phase separation | 30 | 80 | 250 | 9 | 0.95 | 90 |
| 12 | between M and D | | | | | | |
| | M: Structure derived from | 30 | 80 | 250 | 9 | 0.95 | 90 |
| | polycarbonate urethane | | | | | | |
| | D: Structure derived from | 30 | 80 | 250 | 9 | 0.95 | 90 |
| | PPG | | | | | | |

| | | | Evaluation 7 | | |
|---|---|---|---|---|---|
| | | | | | Proportion of |
| | | | Total | Average | number of |
| | | | cross- | cross- | domains having |
| | Evaluation 1 | | sectional | sectional | a cross-sectional |
| | Confirmation and | Evaluation 6 | area of | area of | area of 0.10 to |
| | analysis of | Strain | domains | domains | 13.00 area % |
| | matrix and domain | (μm) | (area %) | (area %) | (number %) |
| Example | Clear phase separation | 0.20 | 25 | 0.10 | 70 |
| 1 | between M and D | | | | |
| | M: Structure derived from | 0.20 | 25 | 0.10 | 70 |
| | polycarbonate urethane | | | | |
| | D: Structure derived from | 0.20 | 25 | 0.10 | 70 |
| | PPG | | | | |
| Example | Same as above | 0.20 | 45 | 0.10 | 70 |
| 2 | | 0.20 | 45 | 0.10 | 70 |
| | | 0.20 | 45 | 0.10 | 70 |
| Example | Same as above | 0.30 | 35 | 6.50 | 90 |
| 3 | | 0.30 | 35 | 6.60 | 90 |
| | | 0.30 | 35 | 6.60 | 90 |
| Example | Clear phase separation | 0.30 | 35 | 6.00 | 90 |
| 4 | between M and D | | | | |
| | M: Structure derived from | 0.30 | 34 | 6.00 | 90 |
| | polycarbonate urethane | | | | |
| | D: Structure derived from | 0.30 | 35 | 6.00 | 90 |
| | tetrahydrofuran-neopentyl | | | | |
| | glycol copolymer | | | | |
| Example | Clear phase separation | 0.30 | 45 | 13.00 | 70 |
| 5 | between M and D | | | | |
| | M: Structure derived from | 0.30 | 45 | 13.00 | 70 |
| | polycarbonate urethane | | | | |
| | D: Structure derived from | 0.30 | 45 | 13.00 | 70 |
| | PPG | | | | |
| Example | Same as above | 0.20 | 25 | 0.10 | 70 |
| 6 | | 0.20 | 25 | 0.10 | 70 |
| | | 0.20 | 25 | 0.10 | 70 |
| Example | Same as above | 0.30 | 35 | 6.50 | 90 |
| 7 | | 0.30 | 35 | 6.60 | 90 |
| | | 0.30 | 35 | 6.60 | 90 |
| Example | Same as above | 0.40 | 35 | 6.00 | 90 |
| 8 | | 0.40 | 34 | 6.00 | 90 |
| | | 0.40 | 35 | 6.00 | 90 |
| Example | Same as above | 0.03 | 22 | 0.10 | 60 |
| 9 | | 0.03 | 22 | 0.05 | 60 |
| | | 0.03 | 22 | 0.05 | 60 |
| Example | Same as above | 0.50 | 48 | 14.90 | 61 |
| 10 | | 0.50 | 48 | 15.00 | 60 |
| | | 0.50 | 48 | 15.00 | 60 |
| Example | Clear phase separation | 0.50 | 35 | 6.60 | 90 |
| 11 | between M and D | | | | |
| | M: Structure derived from | 0.50 | 35 | 6.60 | 90 |
| | polyester urethane | | | | |
| | D: Structure derived from | 0.50 | 35 | 6.60 | 90 |
| | PPG | | | | |
| Example | Clear phase separation | 0.50 | 35 | 6.60 | 90 |
| 12 | between M and D | | | | |
| | M: Structure derived from | 0.50 | 35 | 6.60 | 90 |
| | polycarbonate urethane | | | | |
| | D: Structure derived from | 0.50 | 35 | 6.50 | 90 |
| | PPG | | | | |

TABLE 4-2

| | | | | | | Evaluation 5 | |
|---|---|---|---|---|---|---|---|
| | | | | | | | Proportion of |
| | | | | | | | number of |
| | | | | | Evaluation 4 | | domains |
| | Evaluation 1 | Evaluation 2 | | | Elastic | | having a |
| | Confirmation and | Micro | Evaluation 3 | Evaluation 3 | modulus | Average | circularity of |
| | analysis of matrix | rubber | A | B | of matrix | circularity | 0.60 to 0.95 |
| | and domain | hardness | (mV) | (mV) | (MPa) | of domains | (number %) |
| Comparative | Clear phase | 26 | 260 | 60 | 4 | 0.95 | 90 |
| Example 1 | separation | | | | | | |
| | between M and D | | | | | | |
| | M: Structure | 26 | 260 | 60 | 4 | 0.95 | 90 |
| | derived from | | | | | | |
| | polycarbonate | | | | | | |
| | urethane | | | | | | |
| | D: Structure derived | 26 | 260 | 60 | 4 | 0.95 | 90 |
| | from PPG | | | | | | |
| Comparative | Unclear phase | 28 | 80 | 210 | 6 | 0.50 | 60 |
| Example 2 | separation | | | | | | |
| | between M and D | | | | | | |
| | M: Structure | 28 | 80 | 210 | 6 | 0.50 | 60 |
| | derived from | | | | | | |
| | polycarbonate | | | | | | |
| | urethane | | | | | | |
| | D: Structure | 28 | 80 | 210 | 6 | 0.50 | 60 |
| | derived from PPG | | | | | | |
| Comparative | Clear phase | 60 | 220 | 310 | 13 | 0.95 | 90 |
| Example 3 | separation | | | | | | |
| | between M and D | | | | | | |
| | M: Structure | 60 | 220 | 310 | 13 | 0.95 | 90 |
| | derived from | | | | | | |
| | polycarbonate | | | | | | |
| | urethane | | | | | | |
| | D: Silicone | 60 | 220 | 310 | 13 | 0.95 | 90 |
| Comparative | Clear phase | 50 | 300 | 350 | 20 | 0.50 | 60 |
| Example 4 | separation | | | | | | |
| | between M and D | | | | | | |
| | M: Structure | 50 | 300 | 350 | 20 | 0.50 | 60 |
| | derived from NBR | | | | | | |
| | D: Structure | 50 | 300 | 350 | 20 | 0.50 | 60 |
| | derived from SBR | | | | | | |

| | | | Evaluation 7 | | |
|---|---|---|---|---|---|
| | | | | | Proportion of |
| | | | | | number of |
| | | | Total | Average | domains |
| | | | cross- | cross- | having a cross- |
| | Evaluation 1 | | sectional | sectional | sectional area |
| | Confirmation and | Evaluation 6 | area of | area of | of 0.10 to |
| | analysis of matrix | Strain | domains | domains | 13.00 area % |
| | and domain | (μm) | (area %) | (area %) | (number %) |
| Comparative | Clear phase | 3.00 | 45 | 0.05 | 60 |
| Example 1 | separation | | | | |
| | between M and D | | | | |
| | M: Structure | 3.00 | 45 | 0.05 | 60 |
| | derived from | | | | |
| | polycarbonate | | | | |
| | urethane | | | | |
| | D: Structure derived | 3.00 | 45 | 0.05 | 60 |
| | from PPG | | | | |
| Comparative | Unclear phase | 2.00 | 45 | 13.00 | 70 |
| Example 2 | separation | | | | |
| | between M and D | | | | |
| | M: Structure | 2.00 | 45 | 13.00 | 70 |
| | derived from | | | | |
| | polycarbonate | | | | |
| | urethane | | | | |
| | D: Structure | 2.00 | 45 | 13.00 | 70 |
| | derived from PPG | | | | |
| Comparative | Clear phase | 0.05 | 50 | 5.30 | 90 |
| Example 3 | separation | | | | |
| | between M and D | | | | |
| | M: Structure | 0.05 | 50 | 5.30 | 90 |
| | derived from | | | | |
| | polycarbonate | | | | |
| | urethane | | | | |
| | D: Silicone | 0.05 | 51 | 5.40 | 90 |
| Comparative | Clear phase | 1.50 | 35 | 0.10 | 70 |
| Example 4 | separation | | | | |
| | between M and D | | | | |
| | M: Structure | 1.50 | 34 | 0.10 | 70 |
| | derived from NBR | | | | |
| | D: Structure | 1.50 | 35 | 0.10 | 70 |
| | derived from SBR | | | | |

In Tables 4-1 to 4-2, M represents a matrix, D represents a domain, A and B represent parameters A and B indicating the viscoelasticity term, and PPG represents polypropylene glycol.

TABLE 5

| | | | | Evalua- | Evalua- |
|---|---|---|---|---|---|
| | | Evalua- | Evalua- | tion 9-1 | tion 9-2 |
| | | tion 8-1 | tion 8-2 | Scraping | Toner melt |
| | | Wrinkles | Toner adhesion | of ends | adhesion |
| Example | 1 | A | A | Not occurred | Not occurred |
| | 2 | A | A | Not occurred | Not occurred |
| | 3 | A | A | Not occurred | Not occurred |
| | 4 | A | A | Not occurred | Not occurred |
| | 5 | A | A | Not occurred | Not occurred |
| | 6 | A | A | Not occurred | Not occurred |
| | 7 | A | A | Not occurred | Not occurred |
| | 8 | A | A | Not occurred | Not occurred |
| | 9 | A | A | Not occurred | Occurred on |
| | | | | | 9,000th sheet |
| | 10 | B | B | Not occurred | Not occurred |
| | 11 | B | B | Not occurred | Not occurred |
| | 12 | B | B | Not occurred | Not occurred |
| Compar- | 1 | C | C | Occurred on | Occurred on |
| ative | | | | 8,000th sheet | 5,000th sheet |
| Example | 2 | C | C | Occurred on | Occurred on |
| | | | | 8,000th sheet | 5,000th sheet |
| | 3 | A | A | Not occurred | Occurred on |
| | | | | | 4,000th sheet |
| | 4 | B | A | Occurred on | Occurred on |
| | | | | 3,000th sheet | 3,000th sheet |

In the electrophotographic rollers according to Examples 1 to 8, the micro rubber hardness of the elastic layer was low, and a plurality of domains were dispersed in the matrix containing a urethane elastomer. In addition, the parameter B indicating the viscoelasticity term of the matrix was larger than the parameter A indicating the viscoelasticity term of the domain, the circularity of the domain was high, the elastic modulus of the matrix was also high, and thus good results were obtained in the evaluation of streaky image defects under a high temperature and high humidity environment. In addition, no toner adhesion was observed.

In the electrophotographic roller according to Example 9, the micro rubber hardness was slightly high, and toner melt adhesion was observed after 9,000 sheets were output under a high temperature and high humidity environment.

In the electrophotographic rollers according to Examples 10 to 12, since the micro rubber hardness and the elastic modulus of the matrix were slightly low, the strain after unloading was slightly large, and streaky image defects were observed only on the first sheet under a high temperature and high humidity environment. In addition, although toner adhesion was observed in some regions of the electrophotographic roller, no image defects due to toner adhesion were observed.

On the other hand, in the electrophotographic roller according to Comparative Example 1, the relationship between the domain and the matrix was reversed from that of the urethane elastomer according to Example 1, and the parameter A indicating the viscoelasticity term of the domain was larger than the parameter B indicating the viscoelasticity term of the matrix. Therefore, the micro rubber hardness decreased excessively, the strain after unloading increased, and the evaluation of streaky image defects under a high temperature and high humidity environment was not good. In addition, the mechanical strength was weakened due to an excess decrease in the micro rubber hardness, and the ends of the electrophotographic roller were scraped off. In addition, since the elastic modulus of the matrix was small, toner adhesion occurred, the fixed toner was rubbed off, and toner melt adhesion was observed after 5,000 sheets were output.

In the electrophotographic roller according to Comparative Example 2, a polyether was synthesized and mechanically phase-separated to form a matrix-domain structure without a step of synthesizing a urethane reactive emulsifier. Therefore, the phase separation was unclear. In addition, since the circularity of the domain was also small, the micro rubber hardness decreased excessively and the strain after unloading increased, and the evaluation of streaky image defects was not good under a high temperature and high humidity environment. In addition, the mechanical strength was weakened due to an excess decrease in the micro rubber hardness, and the ends of the electrophotographic roller were scraped off. In addition, the domain component was mixed into the matrix, the phase separation became unclear, and at the same time, the elastic modulus of the matrix decreased, toner adhesion occurred, the fixed toner was rubbed off, and toner melt adhesion was observed after 5,000 sheets were output.

In the electrophotographic roller according to Comparative Example 3, although flexible particles were used as the domains, in order to maintain the shapes of the particles, the parameter A indicating the viscoelasticity term was much larger than that of the domain according to the present disclosure, the parameter B indicating the viscoelasticity term of the matrix should also be made larger, and as a result, the micro rubber hardness became higher. Thus, toner melt adhesion was observed after 4,000 sheets were output under a high temperature and high humidity environment.

In the electrophotographic roller according to Comparative Example 4, since the synthetic rubber was mechanically phase-separated, the circularity of the domain was small, the elastic layer did not uniformly recover from the deformation, and the evaluation of streaky image defects was not good. In addition, in the synthetic rubber, which was weak against wear, wear was accelerated under a high temperature and high humidity environment, the ends were scraped off, and toner adhesion occurred in the scraped parts. The fixed toner was additionally rubbed off, and toner melt adhesion was observed after 3,000 sheets were output.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An electrophotographic member comprising an elastic layer, wherein
an outer surface of the elastic layer constitutes an outer surface of the electrophotographic member,
the elastic layer comprises a urethane elastomer,
the urethane elastomer comprises a matrix and a plurality of domains dispersed in the matrix,
a relationship between a parameter A indicating a viscoelasticity term of the domain and a parameter B indicating a viscoelasticity term of the matrix, which are measured in a viscoelasticity image of a cross section of the elastic layer in which the domain and the matrix are exposed under a scanning probe microscope, satisfies A<B,
a micro rubber hardness of the elastic layer at a temperature of 23° C. is 30 to 50 degrees,
when a length of the elastic layer in a longitudinal direction is L, at a total of three locations including a center of the elastic layer in the longitudinal direction and two locations of L/4 from both ends of the elastic layer toward the center, for each cross section of the elastic layer in a thickness direction in which the domain and the matrix are exposed, in a case where a square observation region having a side of 50 m is a thickness region from the outer surface of the elastic layer to a position of a depth of 100 m, a proportion of the number of domains with a circularity of 0.60 to 0.95 based on a total number of domains observed in the obtained cross section image is at least 70%, and
an elastic modulus of the matrix present in the observation region at a temperature of 23° C. is 9.0 to 35.0 MPa.

2. The electrophotographic member according to claim 1,
wherein, when a Vickers indenter is brought into contact with the matrix at the outer surface of the elastic layer at a temperature of 23° C., the Vickers indenter is pressed into the elastic layer at a load rate of 10 mN/30 seconds, a load of 10 mN is maintained for 60 seconds, and the load is then removed, a strain 5 seconds after unloading is 0.40 μm or less.

3. The electrophotographic member according to claim 1,
wherein, in the observation region, each observation region satisfies requirement (1) and requirement (2) below:
Requirement (1): A proportion of the total cross-sectional area of the domains present in the observation region is 25 to 45 area % of the area of the observation region.
Requirement (2): Among the domains present in the observation region, a proportion of the number of domains having a cross-sectional area of 0.10 to 13.00 area % relative to the area of the observation region is at least 70%.

4. The electrophotographic member according claim 1, wherein
the matrix comprises a polycarbonate structure represented by Formula (1), and
the domain comprises a polyether structure represented by Formula (2): 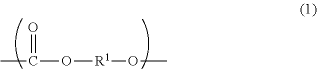
in Formula (1), R¹ represents an alkylene group having 3 to 9 carbon atoms, 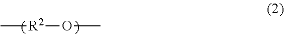
in Formula (2), R² represents an alkylene group having 3 to 5 carbon atoms.

5. The electrophotographic member according to claim 4,
wherein R¹ is an alkylene group having a branched structure and 3 to 9 carbon atoms.

6. The electrophotographic member according to claim 4,
wherein R² is an alkylene group having a branched structure and 3 to 5 carbon atoms.

7. The electrophotographic member according to claim 1,
wherein a value ratio (A/B) of the parameter A to the parameter B is 0.65 or less.

8. A process cartridge configured to be detachable from a main body of an electrophotographic image forming apparatus, wherein
the process cartridge comprises an electrophotographic member,
the electrophotographic member comprises an elastic layer,
an outer surface of the elastic layer constitutes an outer surface of the electrophotographic member,
the elastic layer comprises a urethane elastomer,
the urethane elastomer comprises a matrix and a plurality of domains dispersed in the matrix,
a relationship between a parameter A indicating a viscoelasticity term of the domain and a parameter B indicating a viscoelasticity term of the matrix, which are measured in a viscoelasticity image of a cross section of the elastic layer in which the domain and the matrix are exposed under a scanning probe microscope, satisfies A<B,
a micro rubber hardness of the elastic layer at a temperature of 23° C. is 30 to 50 degrees,
when a length of the elastic layer in a longitudinal direction is L, at a total of three locations including a center of the elastic layer in the longitudinal direction and two locations of L/4 from both ends of the elastic layer toward the center, for each cross section of the elastic layer in a thickness direction in which the domain and the matrix are exposed, in a case where a square observation region having a side of 50 m is a thickness region from the outer surface of the elastic layer to a position of a depth of 100 m, a proportion of the number of domains with a circularity of 0.60 to 0.95 based on a total number of domains observed in the obtained cross section image is at least 70%, and
an elastic modulus of the matrix present in the observation region at a temperature of 23° C. is 9.0 to 35.0 MPa.

9. An electrophotographic image forming apparatus comprising an electrophotographic member, wherein
the electrophotographic member comprises an elastic layer,
an outer surface of the elastic layer constitutes an outer surface of the electrophotographic member,
the elastic layer comprises a urethane elastomer,
the urethane elastomer comprises a matrix and a plurality of domains dispersed in the matrix,
a relationship between a parameter A indicating a viscoelasticity term of the domain and a parameter B indicating a viscoelasticity term of the matrix, which are measured in a viscoelasticity image of a cross section of the elastic layer in which the domain and the matrix are exposed under a scanning probe microscope, satisfies A<B,
a micro rubber hardness of the elastic layer at a temperature of 23° C. is 30 to 50 degrees,
when a length of the elastic layer in a longitudinal direction is L, at a total of three locations including a center of the elastic layer in the longitudinal direction and two locations of L/4 from both ends of the elastic layer toward the center, for each cross section of the elastic layer in a thickness direction in which the domain and the matrix are exposed, in a case where a square observation region having a side of 50 m is a thickness region from the outer surface of the elastic layer to a position of a depth of 100 m, a proportion of the number of domains with a circularity of 0.60 to 0.95 based on a total number of domains observed in the obtained cross section image is at least 70%, and
an elastic modulus of the matrix present in the observation region at a temperature of 23° C. is 9.0 to 35.0 MPa.
